(19) United States
(12) Patent Application Publication
(10) Pub. No.: US 2012/0272162 A1
(43) Pub. Date: Oct. 25, 2012

(54) METHODS AND SYSTEMS FOR VIRTUAL EXPERIENCES

(75) Inventors: Nikolay Surin, San Francisco, CA (US); Tara Lemmey, San Francisco, CA (US); Stanislav Vonog, San Francisco, CA (US)

(73) Assignee: Net Power and Light, Inc., San Francisco, CA (US)

(21) Appl. No.: 13/461,680

(22) Filed: May 1, 2012

Related U.S. Application Data
(63) Continuation of application No. PCT/US11/47814, filed on Aug. 15, 2011.
(60) Provisional application No. 61/373,340, filed on Aug. 13, 2010.

(51) Int. Cl. G06F 3/01; G06F 15/16

(52) U.S. Cl. 715/753

(57) ABSTRACT

The techniques discussed herein contemplate methods and systems for providing interactive virtual experiences. In at least one embodiment of a “virtual experience paradigm,” virtual goods are evolved into virtual experiences. Virtual experiences expand upon limitations imposed by virtual goods by adding additional dimensions to the virtual goods. The virtual experience paradigm further contemplates accounting for user gestures and actions as part of the virtual experience.

### CLAIM OF PRIORITY AND RELATED APPLICATIONS

This application is a continuation of PCT Application No. PCT/US11/47814 filed Aug. 15, 2011, which claims priority to U.S. Provisional Patent Application No. 61/373,340, entitled “METHOD AND SYSTEM FOR VIRTUAL EXPERIENCES”, filed Aug. 13, 2010, which is incorporated in its entirety by this reference:

This application is related to the following U.S. patent applications, each of which is incorporated in its entirety by this reference:
U.S. patent application Ser. No. 13/136,869, entitled “SYSTEM ARCHITECTURE AND METHODS FOR EXPERIENTIAL COMPUTING”, filed Aug. 12, 2011;
U.S. patent application Ser. No. 13/136,870, entitled “EXPERIENCE OR “SENTIO” CODECS, AND METHODS AND SYSTEMS FOR IMPROVING QOE AND ENCODING BASED ON QOE FOR EXPERIENCES”, filed Aug. 12, 2011;
U.S. patent application Ser. No. 13/103,370, entitled “SYSTEM ARCHITECTURE AND METHODS FOR DISTRIBUTED MULTI-SENSOR GESTURE PROCESSING”, filed Aug. 15, 2011.
U.S. patent application Ser. No. 13/367,146, entitled “SYSTEM ARCHITECTURE AND METHODS FOR EXPERIENTIAL COMPUTING”, filed Feb. 6, 2012
U.S. patent application Ser. No. 13/363,187, entitled EXPERIENCE OR “SENTIO” CODECS, AND METHODS AND SYSTEMS FOR IMPROVING QOE AND ENCODING BASED ON QOE FOR EXPERIENCES″, filed Jan. 31, 2012.

### FIELD

The present teaching relates to network communications and more specifically to methods and systems for providing interactive virtual experiences in, for example, social communication platforms.

### BACKGROUND

Virtual goods are non-physical objects that are purchased for use in online communities or online games. They have no intrinsic value and, by definition, are intangible. Virtual goods include such things as digital gifts and digital clothing for avatars. Virtual goods may be classified as services instead of goods and are sold by companies that operate social networks, community sites, or online games. Sales of virtual goods are sometimes referred to as micro-transactions. Virtual reality (VR) is a term that applies to computer-simulated environments that can simulate places in the real world, as well as in imaginary worlds. Most current virtual reality environments are primarily visual experiences, displayed either on a computer screen or through special stereoscopic displays, but some simulations include additional sensory information, such as sound through speakers or headphones. Some advanced, haptic systems now include tactile information, generally known as force feedback, in medical and gaming applications. FIGS. 9A-9C provide examples of prior availability of such virtual goods in the context of social media. For example, FIG. 9A is an example of Facebook® virtual goods (e.g., virtual cupcakes, virtual teddy bears, etc.) that can be exchanged between contacts of a social network. FIG. 9B is another example within a social media (e.g., Farmville®), where users exchange or handle virtual goods in a social environment. FIG. 9C, illustrating an online social game, further adds to examples of virtual goods in the prior art. In such prior art examples, virtual experience, if any, is contained within the electronic device through with a end user accesses the virtual good, and such experience is targeted solely for the benefit of the user. There is no interactive virtual experience that allows the experience to be simultaneously experienced, either synchronously or asynchronously, by several users connected within, for example, a common social communication platform.

### SUMMARY

In at least one embodiment of a “virtual experience paradigm,” virtual goods are evolved into virtual experiences. Virtual experiences expand upon limitations imposed by virtual goods by adding additional dimensions to the virtual goods. By way of example, User A using a first mobile device transmits flowers as a virtual experience to User B accessing a second device. The transmission of the virtual flowers is enhanced by adding emotion by way of sound, for example. The virtual flowers are also changed to a virtual experience when User B can do something with the flowers, for example User B can affect the delivery of flowers through any sort of motion or gesture. For example, a user can cause the flowers to be thrown at the user's screen, causing the flowers to be showered upon an intended target on a user's device and then fall down on the ground subsequently. The virtual experience paradigm further contemplates accounting for user gestures and actions as part of the virtual experience. For example, User A may transmit the virtual goods to User B by making a “throwing” gesture using a mobile device, so as to “toss” the virtual goods to User B.

Some key differences from prior art virtual goods and the virtual experiences of the present application include, for example, the addition of physicality in the conveyance or portrayal of the virtual experience, a sense of togetherness when connecting user devices of two users as part of the virtual experience, causing virtual goods to be transmitted or experienced in a live or substantially live setting, causing emotions to be expressed and experienced in association with virtual goods, accounting for real-time features such as delay in transmission or trajectories of “throws” during transmission of virtual goods, accounting for real-time responses of targets of a portrayed experience, etc.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a system architecture for composing and directing user experiences;

FIG. 2 is a block diagram of a personal experience computing environment;

FIGS. 3-4 illustrates an exemplary personal experience computing environment;

FIG. 5 illustrates an architecture of a capacity datacenter and a scenario of layer generation, splitting, remixing;

FIG. 6 illustrates an exemplary structure of an experience agent;

FIG. 7 illustrates an exemplary Sentio codec operational architecture;

FIG. 8 illustrates an exemplary experience involving the merger of various layers;

FIGS. 9A-9C illustrate prior art depictions of virtual goods;

FIG. 10 illustrates such a scenario of a video ensemble where several users watch a TV game virtually “together;”

FIGS. 11A-11E provide description of exemplary embodiments of system environments that may be used to practice the various techniques discussed herein;

FIGS. 12A-12J depict various illustrative examples of virtual experiences that may be offered in conjunction with the techniques described herein; and

FIG. 13 is another illustrate embodiment of an environment for practicing the techniques discussed herein;

FIG. 14 is an exemplary flow diagram illustrating a virtual experience application;

FIGS. 15-17 depict various examples of virtual experiences;

FIG. 18 is another flow diagram illustrating an example of a virtual experience feed in a social networking environment;

FIG. 19 illustrates animation features related to virtual experiences;

FIG. 20 is a flow diagram illustrating presentation of VE based on device parameters;

FIG. 21 illustrates an exemplary environment of using remote computation in virtual experience input recognition;

FIG. 22 illustrates an exemplary environment of using remote computation in virtual experience presentation;

FIG. 23 is a flow diagram illustrating remote computation in virtual experience presentations;

FIGS. 24A-24C illustrate various examples of virtual experiences;

FIG. 25 is a high-level block diagram showing an example of the architecture for a computer system that can be utilized to implement the techniques discussed herein.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

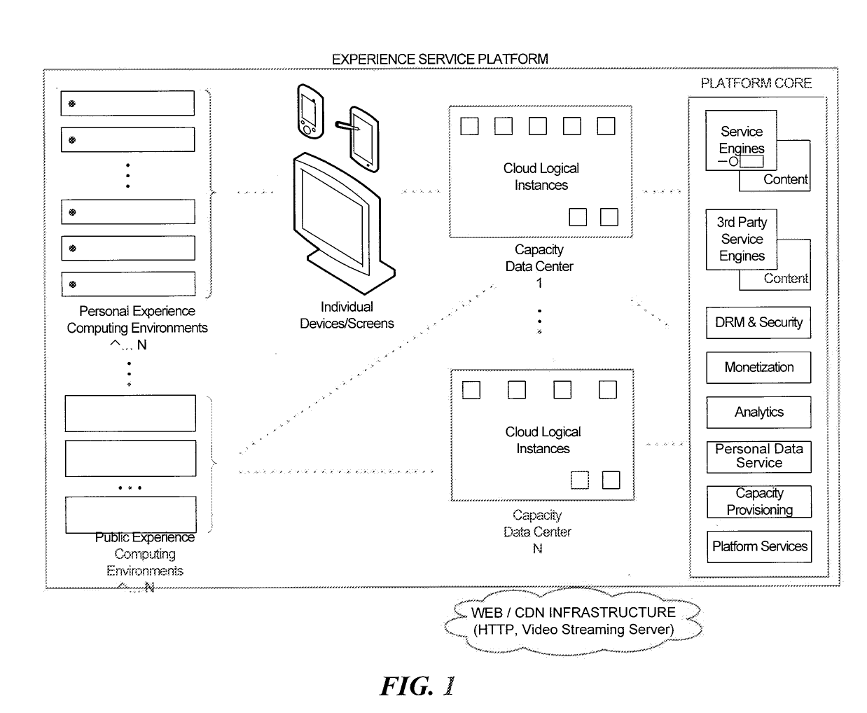

FIG. 1 illustrates an exemplary embodiment of a system that may be used for practicing the techniques discussed herein. The system can be viewed as an “experience platform” or system architecture for composing and directing a participant experience. In one embodiment, the experience platform is provided by a service provider to enable an experience provider to compose and direct a participant experience. The participant experience can involve one or more experience participants. The experience provider can create an experience with a variety of dimensions, as will be explained further now. As will be appreciated, the following description provides one paradigm for understanding the multi-dimensional experience available to the participants. There are many suitable ways of describing, characterizing and implementing the experience platform contemplated herein.

Some of the attributes of “experiential computing” offered through, for example, such an experience platform are: 1) pervasive—it assumes multi-screen, multi-device, multi-sensor computing environments both personal and public; this is in contrast to “personal computing” paradigm where computing is defined as one person interacting with one device (such as a laptop or phone) at any given time; 2) the applications focus on invoking feelings and emotions as opposed to consuming and finding information or data processing; 3) multiple dimensions of input and sensor data—such as physicality; 4) people connected together—live, synchronously: multi-person social real-time interaction allowing multiple people interact with each other live using voice, video, gestures and other types of input.

The experience platform may be provided by a service provider to enable an experience provider to compose and direct a participant experience. The service provider monetizes the experience by charging the experience provider and/or the participants for services. The participant experience can involve one or more experience participants. The experience provider can create an experience with a variety of dimensions and features. As will be appreciated, the following description provides one paradigm for understanding the multi-dimensional experience available to the participants. There are many suitable ways of describing, characterizing and implementing the experience platform contemplated herein.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

In general, services are defined at an API layer of the experience platform. The services are categorized into “dimensions.” The dimension(s) can be recombined into “layers.” The layers form to make features in the experience.

By way of example, the following are some of the dimensions that can be supported on the experience platform.

Video—is the near or substantially real-time streaming of the video portion of a video or film with near real-time display and interaction.

Audio—is the near or substantially real-time streaming of the audio portion of a video, film, karaoke track, song, with near real-time sound and interaction.

Live—is the live display and/or access to a live video, film, or audio stream in near real-time that can be controlled by another experience dimension. A live display is not limited to single data stream.

Encore—is the replaying of a live video, film or audio content. This replaying can be the raw version as it was originally experienced, or some type of augmented version that has been edited, remixed, etc.

Graphics—is a display that contains graphic elements such as text, illustration, photos, freehand geometry and the attributes (size, color, location) associated with these elements. Graphics can be created and controlled using the experience input/output command dimension(s) (see below).

Input/Output Command(s)—are the ability to control the video, audio, picture, display, sound or interactions with human or device-based controls. Some examples of input/output commands include physical gestures or movements, voice/sound recognition, and keyboard or smart-phone device input(s).

Interaction—is how devices and participants interchange and respond with each other and with the content (user experience, video, graphics, audio, images, etc.) displayed in an experience. Interaction can include the defined behavior of an artifact or system and the responses provided to the user and/or player.

Game Mechanics—are rule-based system(s) that facilitate and encourage players to explore the properties of an experience space and other participants through the use of feedback mechanisms. Some services on the experience Platform that could support the game mechanics dimensions include leader boards, polling, like/dislike, featured players, star-ratings, bidding, rewarding, role-playing, problem-solving, etc.

Ensemble—is the interaction of several separate but often related parts of video, song, picture, story line, players, etc. that when woven together create a more engaging and immersive experience than if experienced in isolation.

Auto Tune—is the near real-time correction of pitch in vocal and/or instrumental performances. Auto Tune is used to disguise off-key inaccuracies and mistakes, and allows singer/players to hear back perfectly tuned vocal tracks without the need of singing in tune.

Auto Filter—is the near real-time augmentation of vocal and/or instrumental performances. Types of augmentation could include speeding up or slowing down the playback, increasing/decreasing the volume or pitch, or applying a celebrity-style filter to an audio track (like a Lady Gaga or Heavy-Metal filter).

Remix—is the near real-time creation of an alternative version of a song, track, video, image, etc. made from an original version or multiple original versions of songs, tracks, videos, images, etc.

Viewing 360°/Panning—is the near real-time viewing of the 360° horizontal movement of a streaming video feed on a fixed axis. Also the ability to for the player(s) to control and/or display alternative video or camera feeds from any point designated on this fixed axis.

Turning back to FIG. 1, the exemplary experience platform includes a plurality of personal experience computing environments, each of which includes one or more individual devices and a capacity data center. The devices may include, for example, devices such as an iPhone, an android, a set top box, a desktop computer, a netbook, or other such computing devices. At least some of the devices may be located in proximity with each other and coupled via a wireless network. In certain embodiments, a participant utilizes multiple devices to enjoy a heterogeneous experience, such as, for example, using the iPhone to control operation of the other devices. Participants may, for example, view a video feed in one device (e.g., an iPhone) and switch the feed to another device (e.g., a netbook) to switch the feed to a larger display device. In other examples, multiple participants may also share devices at one location, or the devices may be distributed across various locations for different participants.

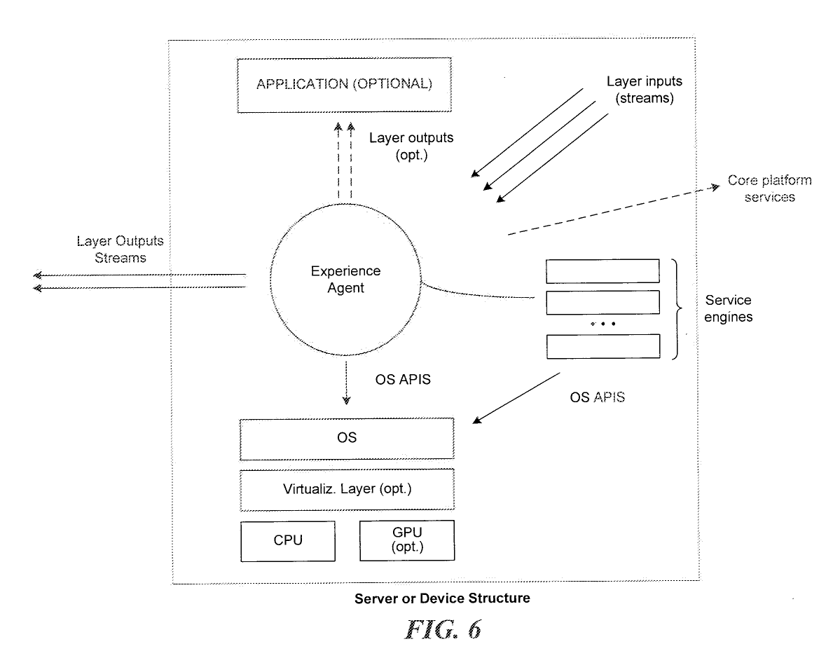

Each device or server has an experience agent. In some embodiments, the experience agent includes a sentio codec and an API. The sentio codec and the API enable the experience agent to communicate with and request services of the components of the data center. In some instances, the experience agent facilitates direct interaction between other local devices. Because of the multi-dimensional aspect of the experience, in at least some embodiments, the sentio codec and API are required to fully enable the desired experience. However, the functionality of the experience agent is typically tailored to the needs and capabilities of the specific device on which the experience agent is instantiated. In some embodiments, services implementing experience dimensions are implemented in a distributed manner across the devices and the data center. In other embodiments, the devices have a very thin experience agent with little functionality beyond a minimum API and sentio codec, and the bulk of the services and thus composition and direction of the experience are implemented within the data center. The experience agent is further illustrated and discussed in FIG. 6.

The experience platform further includes a platform core that provides the various functionalities and core mechanisms for providing various services. In embodiments, the platform core may include service engines, which in turn are responsible for content (e.g., to provide or host content) transmitted to the various devices. The service engines may be endemic to the platform provider or may include third party service engines. The platform core also, in embodiments, includes monetization engines for performing various monetization objectives. Monetization of the service platform can be accomplished in a variety of manners. For example, the monetization engine may determine how and when to charge the experience provider for use of the services, as well as tracking for payment to third-parties for use of services from the third-party service engines. Additionally, in embodiments, the service platform may also include capacity provisioning engines to ensure provisioning of processing capacity for various activities (e.g., layer generation, etc.). The service platform (or, in instances, the platform core) may include one or more of the following: a plurality of service engines, third party service engines, etc. In some embodiments, each service engine has a unique, corresponding experience agent. In other embodiments, a single experience can support multiple service engines. The service engines and the monetization engines can be instantiated on one server, or can be distributed across multiple servers. The service engines correspond to engines generated by the service provider and can provide services such as audio remixing, gesture recognition, and other services referred to in the context of dimensions above, etc. Third party service engines are services included in the service platform by other parties. The service platform may have the third-party service engines instantiated directly therein, or within the service platform 46 these may correspond to proxies which in turn make calls to servers under control of the third-parties.

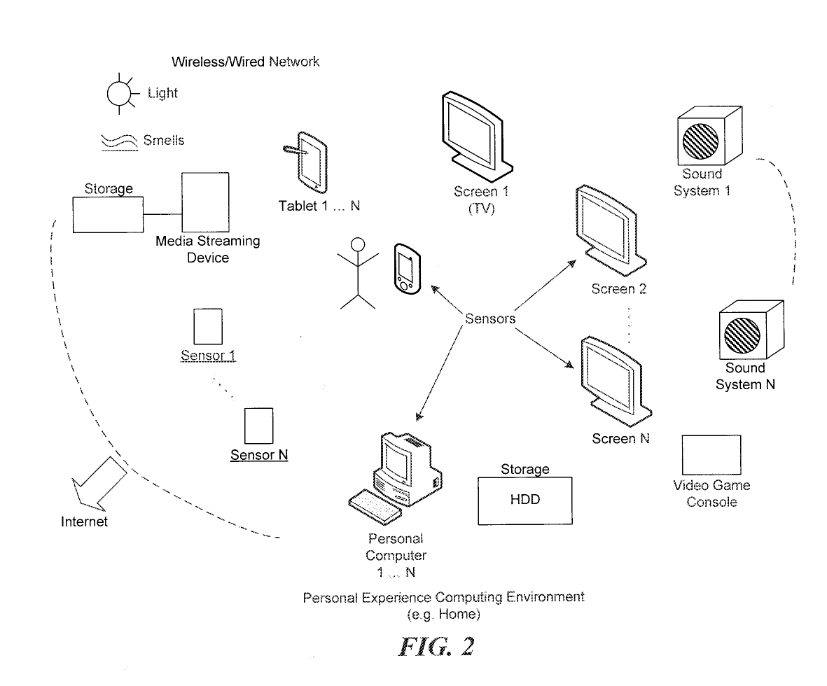

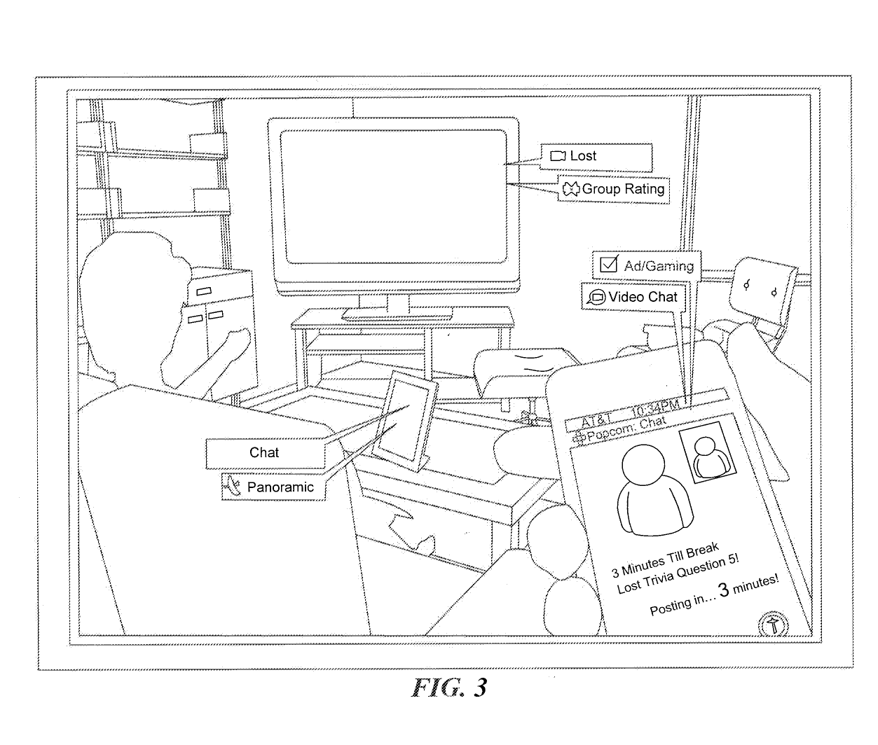

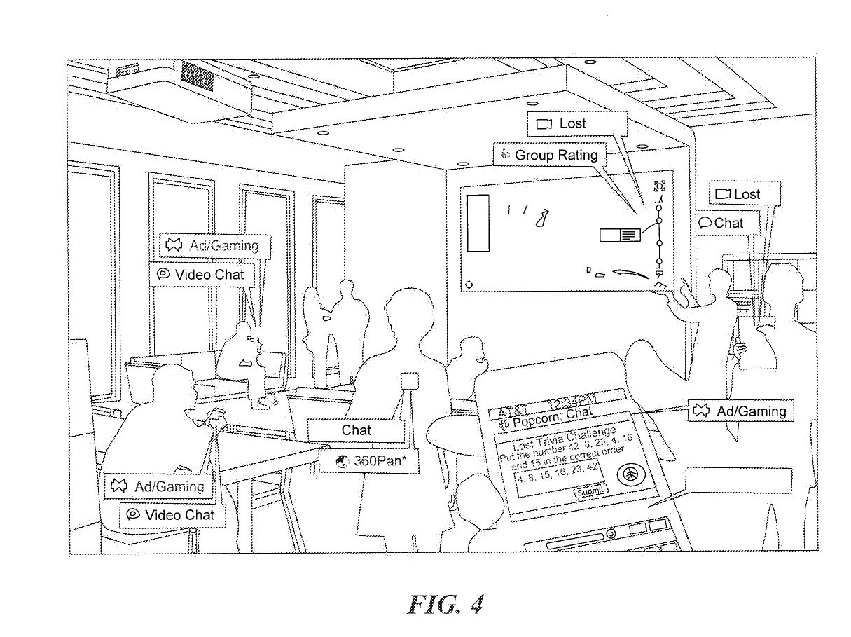

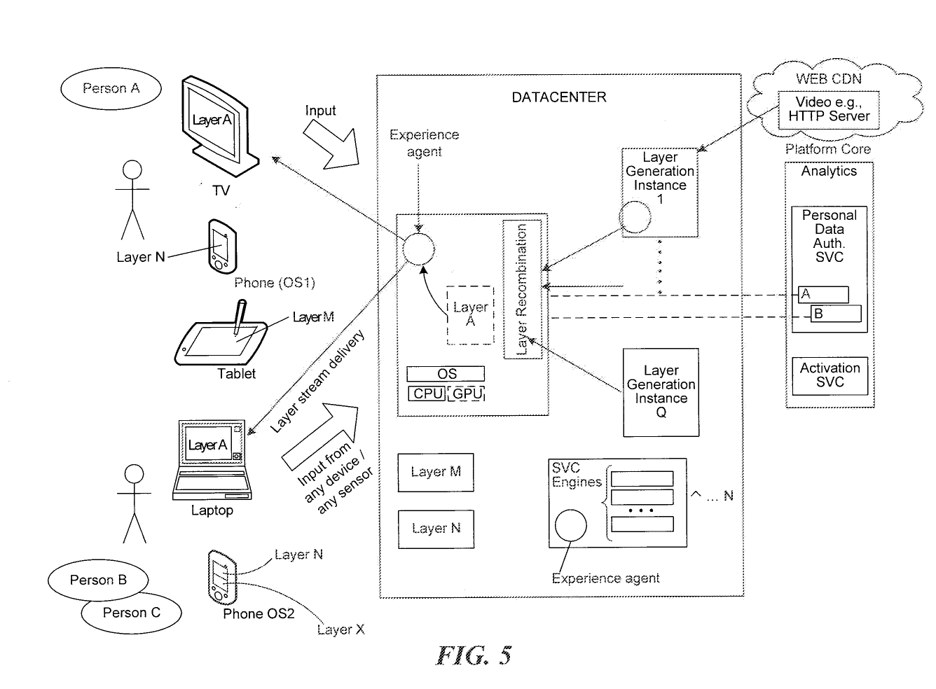

FIG. 2 illustrates a block diagram of a personal experience computing environment. An exemplary embodiment of such a personal experience computing environment is further discussed in detail, for example, with reference to FIGS. 3,4, and 9.

As illustrated in FIG. 6, the data center includes features and mechanisms for layer generation. The data center, in embodiments, includes an experience agent for communicating and transmitting layers to the various devices. As will be appreciated, data center can be hosted in a distributed manner in the “cloud,” and typically the elements of the data center are coupled via a low latency network. FIG. 6 further illustrates the data center receiving inputs from various devices or sensors (e.g., by means of a gesture for a virtual experience to be delivered), and the data center causing various corresponding layers to be generated and transmitted in response. The data center includes a layer or experience composition engine. In one embodiment, the composition engine is defined and controlled by the experience provider to compose and direct the experience for one or more participants utilizing devices. Direction and composition is accomplished, in part, by merging various content layers and other elements into dimensions generated from a variety of sources such as the service provider, the devices, content servers, and/or the service platform. As with other components of the platform, in embodiments, the data center includes an experience agent for communicating with, for example, the various devices, the platform core, etc. The data center may also comprise service engines or connections to one or more virtual engines for the purpose of generating and transmitting the various layer components. The experience platform, platform core, data center, etc. can be implemented on a single computer system, or more likely distributed across a variety of computer systems, and at various locations.

The experience platform, the data center, the various devices, etc. include at least one experience agent and an operating system, as illustrated, for example, in FIG. 6. The experience agent optionally communicates with the application for providing layer outputs. In instances, the experience agent is responsible for receiving layer inputs transmitted by other devices or agents, or transmitting layer outputs to other devices or agents. In some instances, the experience agent may also communicate with service engines to manage layer generation and streamlined optimization of layer output.

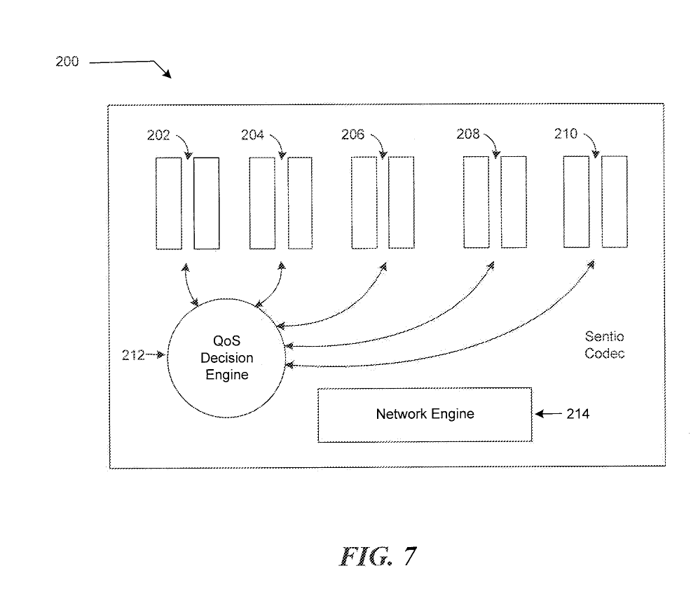

FIG. 7 illustrates a block diagram of a sentio codec 200. The sentio codec 200 includes a plurality of codecs such as video codecs 202, audio codecs 204, graphic language codecs 206, sensor data codecs 208, and emotion codecs 210. The sentio codec 200 further includes a quality of service (QoS) decision engine 212 and a network engine 214. The codecs, the QoS decision engine 212, and the network engine 214 work together to encode one or more data streams and transmit the encoded data according to a low-latency transfer protocol supporting the various encoded data types. One example of this low-latency protocol is described in more detail in Vonog et al.'s U.S. patent application Ser. No. 12/569,876, filed Sep. 29, 2009, and incorporated herein by reference for all purposes including the low-latency protocol and related features such as the network engine and network stack arrangement.

The sentio codec 200 can be designed to take all aspects of the experience platform into consideration when executing the transfer protocol. The parameters and aspects include available network bandwidth, transmission device characteristics and receiving device characteristics. Additionally, the sentio codec 200 can be implemented to be responsive to commands from an experience composition engine or other outside entity to determine how to prioritize data for transmission. In many applications, because of human response, audio is the most important component of an experience data stream. However, a specific application may desire to emphasize video or gesture commands.

The sentio codec provides the capability of encoding data streams corresponding with many different senses or dimensions of an experience. For example, a device may include a video camera capturing video images and audio from a participant. The user image and audio data may be encoded and transmitted directly or, perhaps after some intermediate processing, via the experience composition engine, to the service platform where one or a combination of the service engines can analyze the data stream to make a determination about an emotion of the participant. This emotion can then be encoded by the sentio codec and transmitted to the experience composition engine, which in turn can incorporate this into a dimension of the experience. Similarly a participant gesture can be captured as a data stream, e.g. by a motion sensor or a camera on device, and then transmitted to the service platform, where the gesture can be interpreted, and transmitted to the experience composition engine or directly back to one or more devices 12 for incorporation into a dimension of the experience.

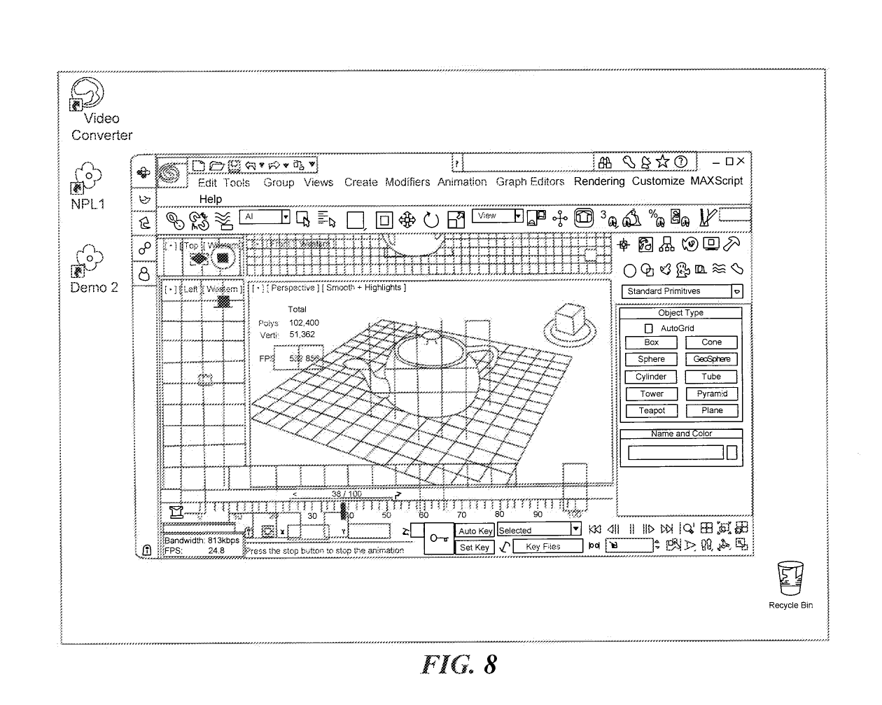

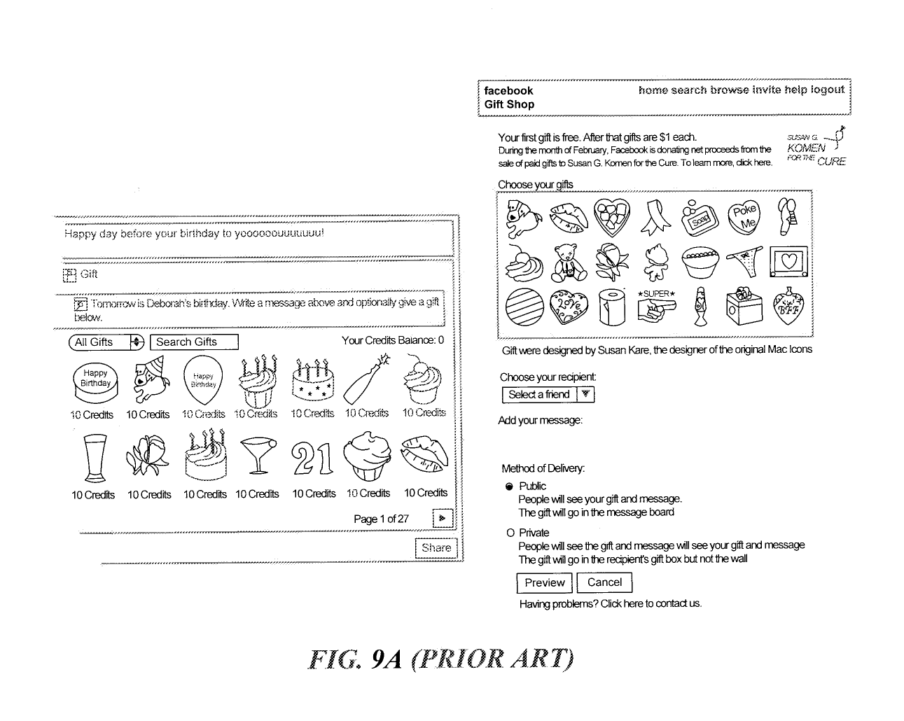

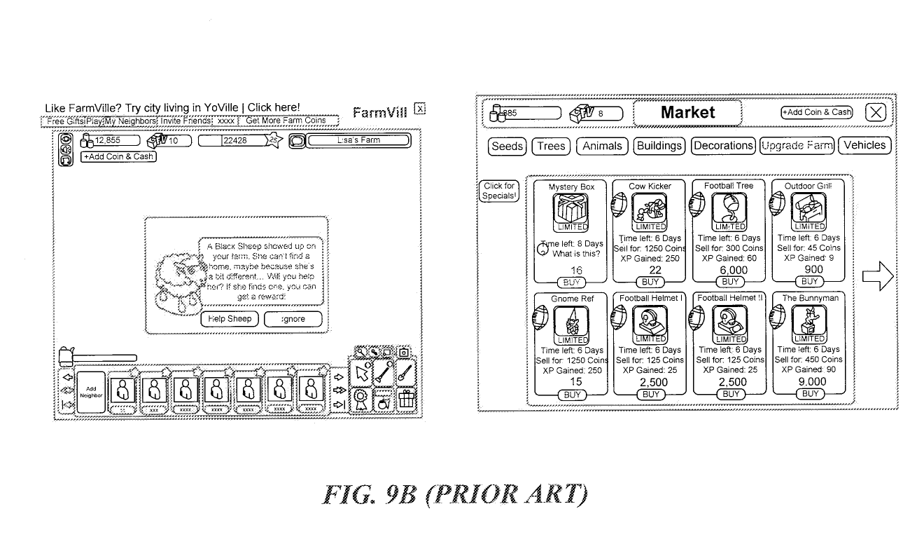

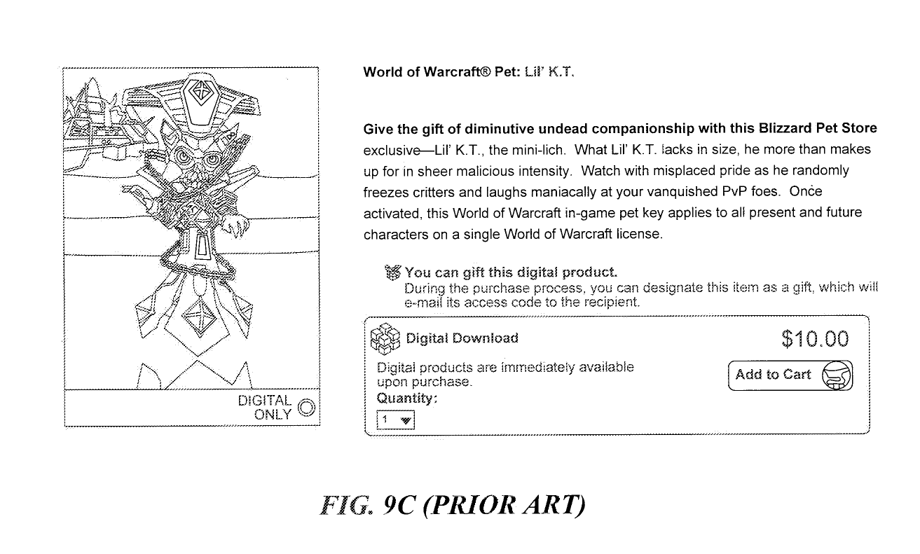

FIG. 8 provides an example experience showing 4 layers. These layers are distributed across various different devices. For example, a first layer is Autodesk 3ds Max instantiated on a suitable layer source, such as on an experience server or a content server. A second layer is an interactive frame around the 3ds Max layer, and in this example is generated on a client device by an experience agent. A third layer is the black box in the bottom-left corner with the text “FPS” and “bandwidth”, and is generated on the client device but pulls data by accessing a service engine available on the service platform. A fourth layer is a red-green-yellow grid which demonstrates an aspect of the low-latency transfer protocol (e.g., different regions being selectively encoded) and is generated and computed on the service platform, and then merged with the 3ds Max layer on the experience server.

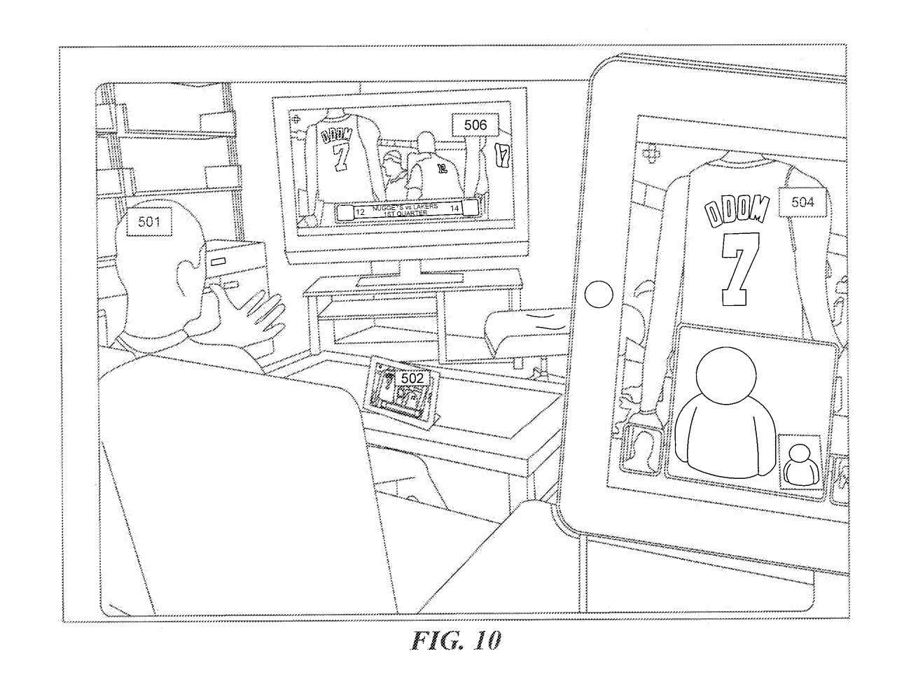

The description above illustrated how a specific application, an “experience,” can operate and how such an application can be generated as a composite of layers. FIGS. 10-12, explained below in detail, now illustrate methods and systems providing virtual experiences to users in conjunction with, for example, the platform discussed above. In the description below, the virtual experiences are discussed in the context of a “virtual experience paradigm.”

In at least one embodiment of a “virtual experience paradigm,” virtual goods are evolved into virtual experiences. Virtual experiences expand upon limitations imposed by virtual goods by adding additional dimensions to the virtual goods. By way of example, User A using a first mobile device transmits flowers as a virtual experience to User B accessing a second device. The transmission of the virtual flowers is enhanced by adding emotion by way of sound, for example. The virtual flowers are also changed to a virtual experience when User B can do something with the flowers, for example User B can affect the delivery of flowers through any sort of motion or gesture. For example, a user can cause the flowers to be thrown at the user's screen, causing the flowers to be showered upon an intended target on a user's device and then fall down on the ground subsequently. The virtual experience paradigm further contemplates accounting for user gestures and actions as part of the virtual experience. For example, User A may transmit the virtual goods to User B by making a “throwing” gesture using a mobile device, so as to “toss” the virtual goods to User B.

Some key differences from prior art virtual goods and the virtual experiences of the present application include, for example, the addition of physicality in the conveyance or portrayal of the virtual experience, a sense of togetherness when connecting user devices of two users as part of the virtual experience, causing virtual goods to be transmitted or experienced in a live or substantially live setting, causing emotions to be expressed and experienced in association with virtual goods, accounting for real-time features such as delay in transmission or trajectories of “throws” during transmission of virtual goods, accounting for real-time responses of targets of a portrayed experience, etc.

For example, consider a scenario where several users are connected over in a social media interaction through their respective user devices. The users may be able to, for example, engage in video chats or audio chats with each other within the social interactive platform. Further, consider a case where the users are watching a telecast of a soccer game over their respective devices. In essence, a sense of togetherness is conveyed through this virtual experience where the users are virtually watching the game together similar to a real-life scenario (where the users would have watched the game together in a single room). Here, since the users are able to see and communicate each with each other through the social platform that is offered as part of the virtual experience paradigm, each user can observe and/or share real-time experiences of the game with the other users. In addition to the above features where a real-life virtual experience is provided, users may, for example, partake in actions that allow them to express emotions. For example, a user may wish to throw flowers (or rotten tomatoes as the case may be) at the players as a result of an outstanding achievement of a player during the game (or a terrible performance of the player in the case of rotten tomatoes being thrown). The user may select such a virtual good (i.e., the flowers) and cause the flowers to be flung over in the direction of the player. As part of the virtual experience paradigm, not only do the flowers get displayed on every user's screen as a result of one user throwing the flowers at a player, but a real-life virtual experience is created as well as part of the paradigm. For example, when a user throws a rotten tomato, a tomato may be caused to be “swooshed” from one side of the screen (e.g., it appears as through the tomato enters the screen from behind the user) and travels a trajectory to hit the intended target (or hit a target based on a trajectory at which the user threw the tomato). While traversing the users' screens, a “swoosh” sound may also accompany the portrayed experience for an addition real-life imitation. When the tomato finally hits a target, a “splat” sound, for example, may be played, along with an animation of the tomato being crushed or “splat” on the screen, All such experiences, and other examples as a person of ordinary skill in the art would consider as a virtual experience addition in such scenarios, are additionally contemplated.

In addition to addition experience dimensionalities to the virtual goods, the paradigm further contemplates incorporation of physical dimensions. For example, in one example, the user may simply initiate an experience action (e.g., throwing a tomato) by selecting an object on his device and causing the object to be thrown in a direction using, for example, mouse pointers. In other examples, the paradigm may offer a further dimension of “realness” by allowing the user to physically throw or pass the virtual object along. For example, in an illustrative setting, the user may select a tomato to be thrown, and then use his personal mobile or other computing device to physically emulate the action of throwing the tomato in a selected direction. For example, the virtual experience paradigm may take advantage of motion sensors available on a user's device to emulate a physical action. In the illustrative example, the user may then select a tomato and then simply swing his motion sensor-fitted device (e.g., a Wii remote, an iPhone, etc.) in a direction toward another computing device (e.g., the device that is playing the soccer game), causing the virtual tomato to be hurled across toward the other screen. Here, in embodiments, the paradigm may account for the direction and velocity of the swing to determine the animation sequence of the virtual tomato to be traversed and thrown in different screens. This example may further be extended to a scenario, for example, where several users may actually be in the same room watching the game on a large screen computing device while also engaged in a social platform through their respective user devices. In such scenarios, a user may selectively cause the tomato to be thrown at just the large screen device or on every user device. In embodiments, the user may also selectively cause the virtual experience to be portrayed only with respect to one or more selected users as opposed to every user connected through the social platform.

FIG. 10 illustrates such a scenario of a video ensemble where several users watch a TV game virtually “together.” A first user 501 watches the show using a tablet device 502. A second user (not shown) watches the show using another handheld computing device 504. Both users are connected to each other over a social platform (enabled, for example, using the experience platform discussed in reference to FIGS. 1-2) and can see videos of each other and also communicate with each other (video or audio from the social platform may be superimposed over the TV show as illustrated in the figure). Further at least some users watch also watch the same game on a large screen display device 506 that is located in the same physical room. The following section depicts one illustrative scenario of how user A 502 throws a rotten tomato over a that is playing over a social media (in a large display screen in a room that has several users with personal mobile devices connected to the virtual experience platform). As part of a virtual experience, user A may, in the illustrative example, portray the physical action of throwing a tomato (after choosing a tomato that is present as a virtual object) by using physical gestures on his screen (or by emulating physical gestures by emulating a throwing action of his tablet device). This physical action causes a tomato to move from the user's mobile device in an interconnected live-action format, where the virtual tomato first starts from the user's device, pans across the screen of the user's tablet device in a direction of the physical gesture, and after leaving the boundary of the screen of the user's mobile device, is then shown as hurling across through the central larger screen 506 (with appropriate delays to enhance reality of the virtual experience), and finally be splotched on the screen with appropriate virtual displays. In this example, the direction and trajectory of the transferred virtual object is dependent on the physical gesture (in this example). In addition to the visual experience, accompanying sound effects further add to the overall virtual experience. For example, when the “tomato throw” starts from the user's tablet device 502, a swoosh sound first emanates from the user's mobile device and then follows the visual cues (e.g., sound is transferred to the larger device 506 when visual display of tomato first appears on the larger device 506) to provide a more realistic “throw” experience.

While this example illustrates a very elementary and exemplary illustration of virtual experiences, such principles can be ported to numerous applications that involve, for example, emotions surrounding everyday activities, such as, for example, watching sports activities together, congratulating other users on personal events or accomplishments on a shared online game, etc. It is contemplated that the above illustrative example may be extended to numerous other circumstances where one or more virtual goods may be portrayed along with emotions, physicality, dimensionality, etc. that provide users an overall virtual experience. In essence, the paradigm removes two-dimensionality of user's experiences when using commonplace computing devices. For example, when a virtual good is conveyed in prior art systems, a user receives an email or message notification as to the availability of the virtual good. Music and other multimedia experiences may be offered in conjunction with the virtual good, but such prior art virtual goods do not offer virtual experiences that transcend the boundaries of their computing devices. In contrast, the virtual paradigm described herein is not constrained by the boundaries of each user's computing device. A virtual good conveyed in conjunction with a virtual experience is carried from one device to another in a way a physical experience may be conveyed, where the boundaries of each user's physical device is disregarded. For example, in an exemplary illustration, when a user throws a tomato from one device to another within a room, the tomato exits the display of the first device as determined by a trajectory of “throw” of the tomato, and enters the display of the second device as determined by the same trajectory.

Such transfer of emotions and other such factors over the virtual experiences context may pan over multiple computing devices, sensors, displays, displays within displays or split displays, etc. The overall rendering and execution of the virtual experiences may be specific to each local machine or may all be controlled overall over a cloud environment (e.g., Amazon cloud services), where a server computing unit on the cloud maintains connectivity (e.g., using APIs) with the devices associated with the virtual experience platform. The overall principles discussed herein are directed to synchronous and live experiences offered over a virtual experience platform. Asynchronous experiences are also contemplated. Synchronization of virtual experiences may pan displays of several devices, or several networks connected to a common hub that operates the virtual experience.

Monetization of the virtual experience platform is envisioned in several forms. For example, users may purchase virtual objects that they wish to utilize in a virtual experience (e.g., purchase a tomato to use in the virtual throw experience), or may even purchase virtual events such as the capability of purchasing three tomato throws at the screen. In some aspects, the monetization model may also include use of branded products (e.g., passing around a 1800-Flowers bouquet of flowers to convey an emotional experience, where the relevant owner of the brand may also compensate the platform for marketing initiatives). Such virtual experiences may pan simple to complex scenarios. Examples of complex scenarios may include a virtual birthday party or a virtual football game event where several users are connected over the Internet to watch a common game or a video of the birthday party. The users can see each other over video displays and selectively or globally communicate with each other. Users may then convey emotions by, for example throwing tomatoes at the screen or by causing fireworks to come up over a momentous occasion, which is then propagated as an experience over the screens.

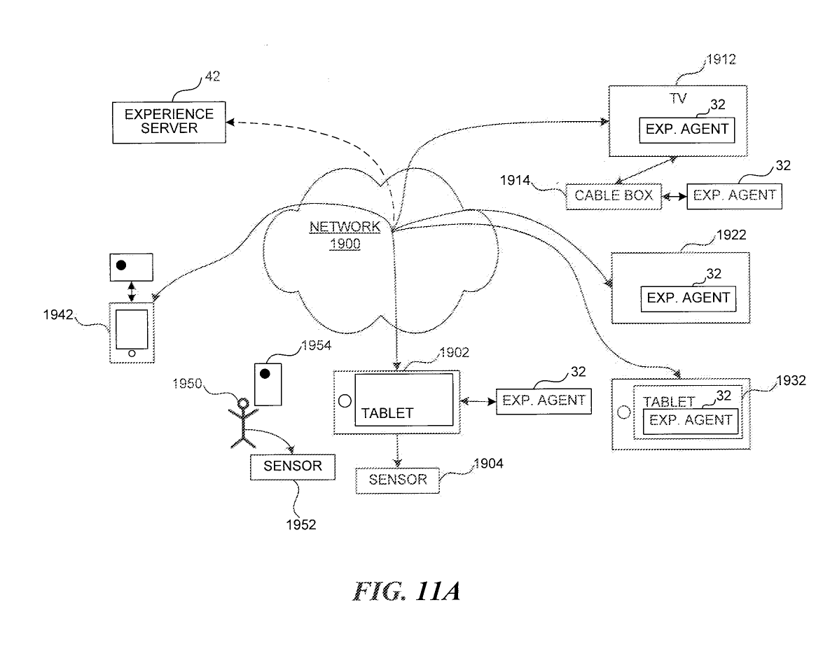

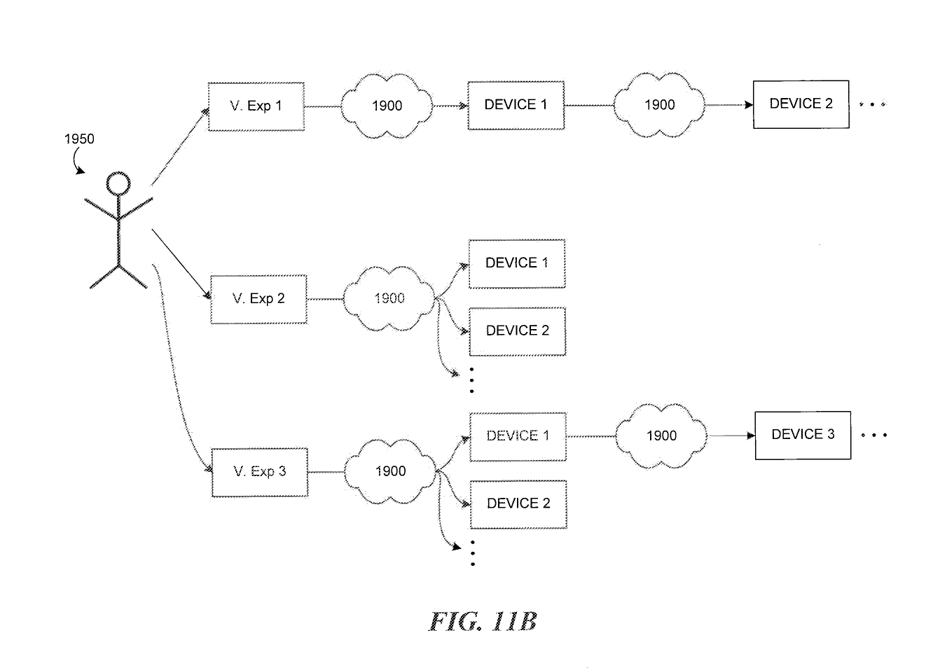

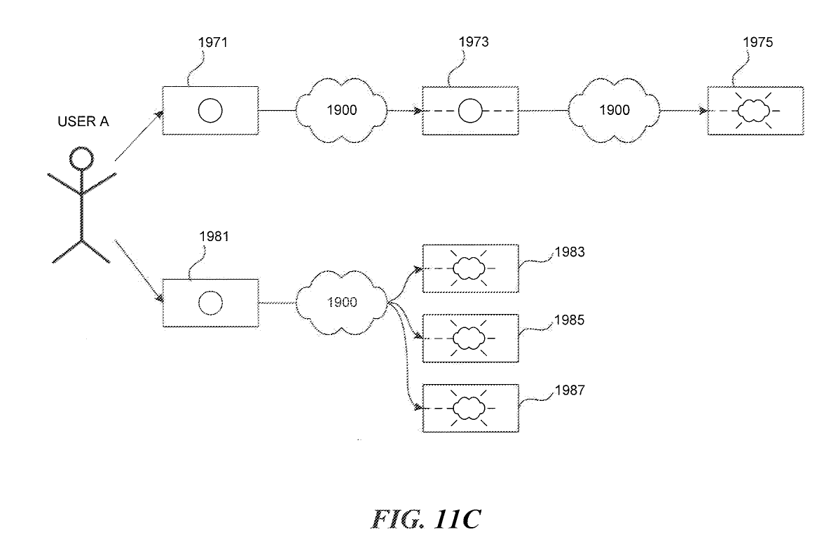

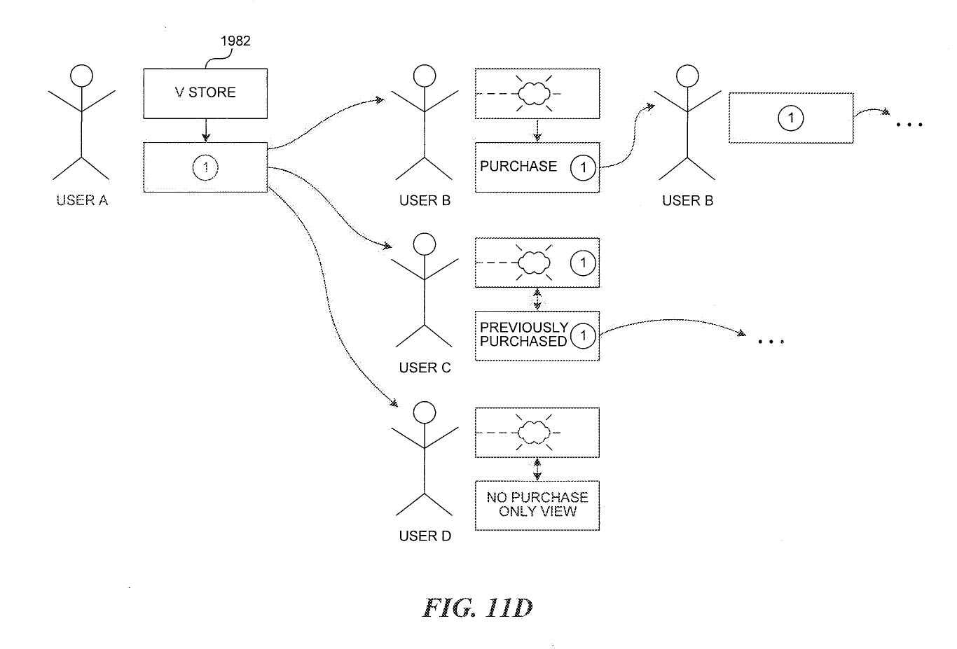

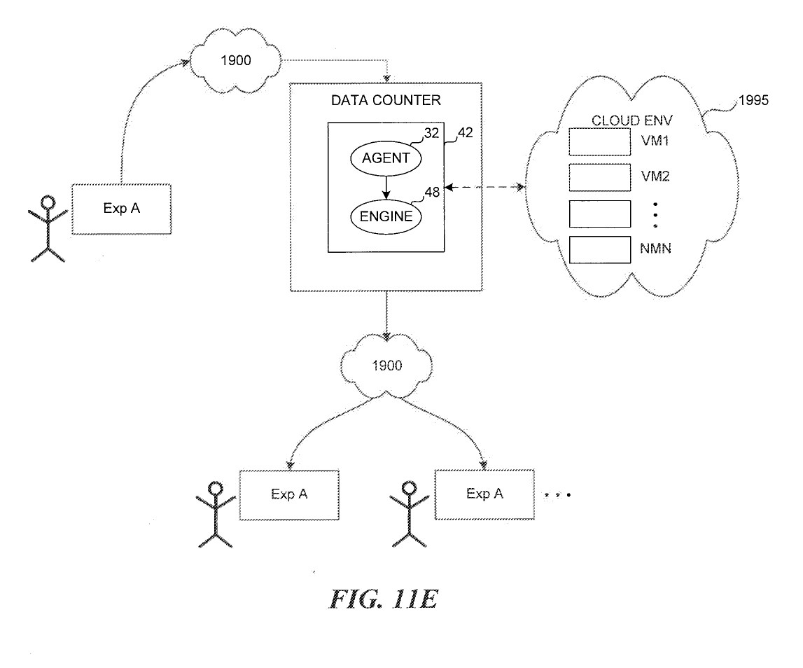

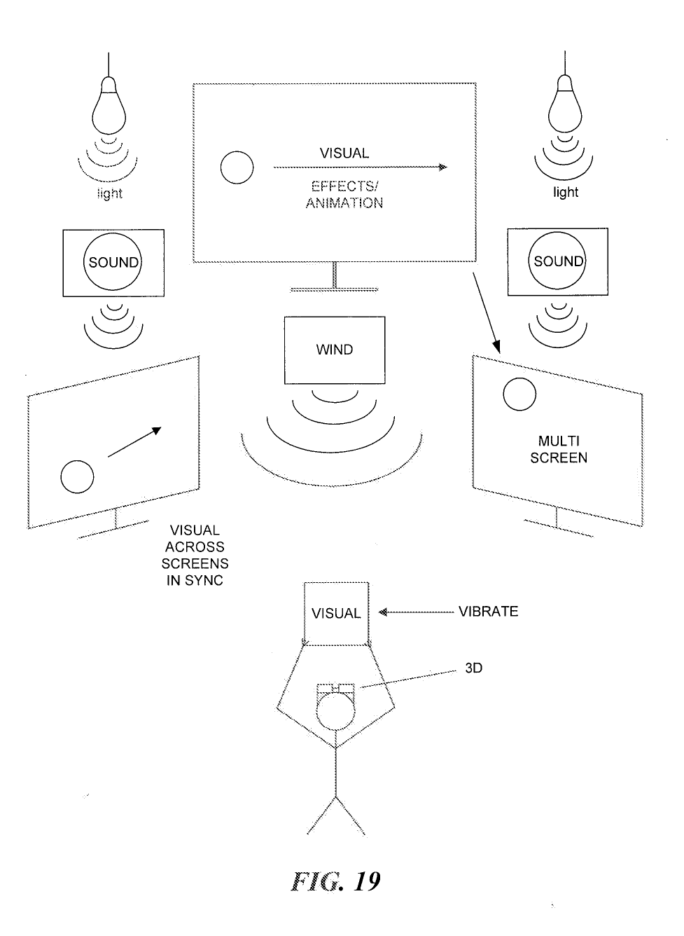

The above discussion provided a detailed description of the fundamentals involved in the virtual experience paradigm. The following description, with reference to FIGS. 11A-11E now provide description of exemplary embodiments of system environments that may be used to practice the various techniques discussed herein. FIG. 11A discusses an example of a system environment that practices the virtual paradigm. Here, for example, several users are connected to a common social networking event (e.g., watching a football game together virtually connected on a communication platform). FIG. 19A represents a scenario of a synchronous virtual experience environment (although it can also be used for asynchronous virtual experiences as discussed further below). User 1950 utilizes, for example, a tablet device 1902 to participate in the virtual experience. User 1950 may use sensors 1904 (e.g., mouse pointers, physical movement sensors, etc.) that are built within the tablet 1902 or may simply use a separate sensor device 1952 (e.g., a smart phone that can detect movement 1954, a Wii® controller, etc.) for gesture indications. In embodiments, the tablet 190 and/or the phone 1954 are all fitted (or installed) with experience agent instantiations. These experience agents and their operational features are discussed above in detail with reference to FIGS. 1-2. An experience serve, may for example, be connected with the various interconnected devices over a network 1900. As discussed above, the experience server may be a single server offering all computational resources for providing virtual goods, creating virtual experiences, and managing provision of experience among the various interconnected user devices. In other examples, the experience server may be instantiated as one or more virtual machines in a cloud computing environment connected with network 1900. As explained above, the experience server may communicate with the user devices via experience agents. In at least some embodiments, the experience server may use Sentio code (e.g., 104 from FIG. 3) for communication and virtual experience computational purposes.

When a user initiates a virtual experience, the experience is propagated as desired to one or more of other connected devices that are connected with the user for a particular virtual experience paradigm setting (e.g., a setting where a group of friends are connected over a communication platform to watch a video stream of a football game, as illustrated, e.g., in FIG. 10). When the virtual experience is initiated by user 1950, the experience may be synchronously or asynchronously conveyed to the other devices. In one example, an experience (throw of a tomato) is conveyed to one or more of several devices. The devices in the illustrated scenario include, for example, a TV 1912. The TV 1912 may be a smart TV capable of having an experience agent of its own, or may communicate with the virtual experience paradigm using, for example, experience agent 32 installed in a set top box 1914 connected to the TV 1912. Similarly, another connected device could be a laptop 1922, or a tablet 1932, or a mobile device 1942 with an experience agent 32 installation.

FIG. 11B illustrates examples of how virtual experiences may be conveyed. In a first example, a first virtual experience, VEXP1 may be asynchronously panned across several connected devices. In the above example of a tomato throw, VEXP1 may be used to first pan the tomato being hurled at a trajectory across device 1 (which may be a TV or a laptop display, for example), and when the tomato “exits” from the boundaries of device 1, it may then “enter” the boundary of device 2 and pan across the screen of device 2 and “splat” somewhere on the screen on device 2 (or further exit from device 2 and go on until the “splat” occurs on a desired device). This is an example of a virtual experience where the various devices participating in the experience the virtual object asynchronously. The second experience illustrated in FIG. 11B is an example of a synchronous virtual experience VEXP2. Here, when the tomato, for example, is hurled from a device associated with user 1950, the tomato “enters” all connected devices synchronously, travels a trajectory, and “splats” on all these devices substantially synchronously as well. It is contemplated that network latency delays may affect perfect synchronization in all connected devices. A third virtual experience, VEXP3, as illustrated in FIG. 11B incorporates both asynchronous and synchronous combination in the delivery of the virtual experience. FIG. 11C illustrates examples of such an asynchronous (1971) and synchronous (1981) delivery of virtual experience, with respect to the “tomato throw” example illustrated above.

FIG. 11D now illustrates exemplary embodiments of monetization methodologies in the virtual experience paradigm. In one example, the data center or the experience server may operate a virtual experience store where users could purchase one or more virtual objects (e.g., tomatoes, flowers, etc.) or even purchase vivid virtual experiences (e.g., an asynchronous throw feature for a certain price, a synchronous throw feature for another price, etc.). In some examples, the experience server, for example, may offer an interface to other online vendors (e.g., an online flower delivery company) that may offer their products as virtual goods to be embodied in virtual experiences. Users may also opt to purchase virtual goods or experiences for themselves, or for use by their entire community for a different price. For example, when a user purchases a tomato and/or a virtual throw experience associated with the virtual tomato, the user can just purchase it for himself. In such a case, the tomato may just be “splat” on the other users' terminals. They would have to purchase the virtual good or the experience separately to be able to use it again for throwing. Such is the scenario explained with respect to the experience between User A and User B in FIG. 11D. User B purchases the virtual good again from the virtual store to be able engage in a new virtual experience using the same virtual good. User D has not purchased the virtual good, so is able to only be the beneficiary of a virtual experience conveyed by another, but cannot partake or initiate his own experience. User C has already pre-purchased the virtual good and experience, so is able to freely use the experience again in a different context. In some instances, user A may wish to purchase unlimited experiences for reuse by other users of his community as well, and may pay a higher price for such an experience. In such a case, user D would then be able to reuse the experience even if user D does not purchase it separately. Several other similar monetization methodologies, as may be contemplated by one or ordinary skill in the art, may also be used in conjunction with or in lieu of the above examples.

FIG. 11E illustrates an example of creation of a virtual experience. When a user requests a certain virtual experience, say VEXP A, in some embodiments, the experience server, for example, receives the request using an agent, and then uses the composition engine to generate the virtual experience. The experience server may in some instances utilize computational resources of its own (or servers attached to the experience server), or in other circumstances, perform the computation using several virtual machines instantiated in a cloud computing network 1995. Subsequent to generating the virtual good(s) and associated animation, the experience server may then transmit either synchronously or asynchronously (as the case may be) the virtual experience to the various relevant devices. In some examples, the experience server 32 may organize the virtual machines in an efficient manner so as to ensure near-simultaneous feed and minimal latency associated with playback of the animation associated with the virtual experience. Examples of such efficient utilization of virtual machines are explained in detail in U.S. patent application Ser. No. 13/165,710, entitled “Just-in-time Transcoding of Application Content,” which is incorporated in its entirely herein.

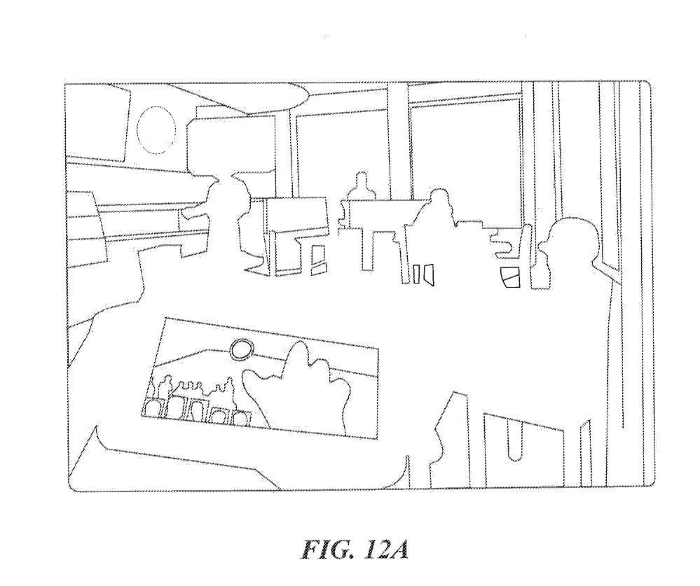

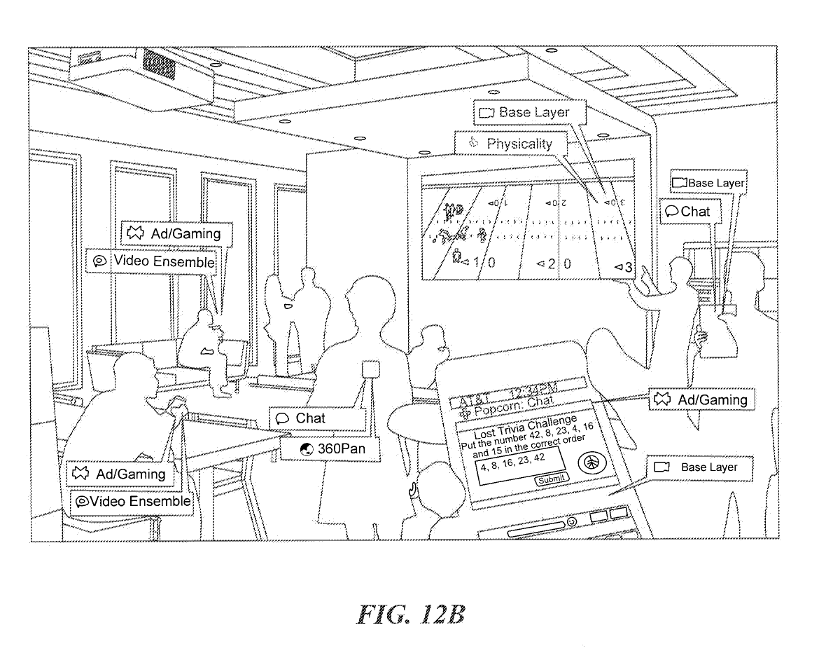

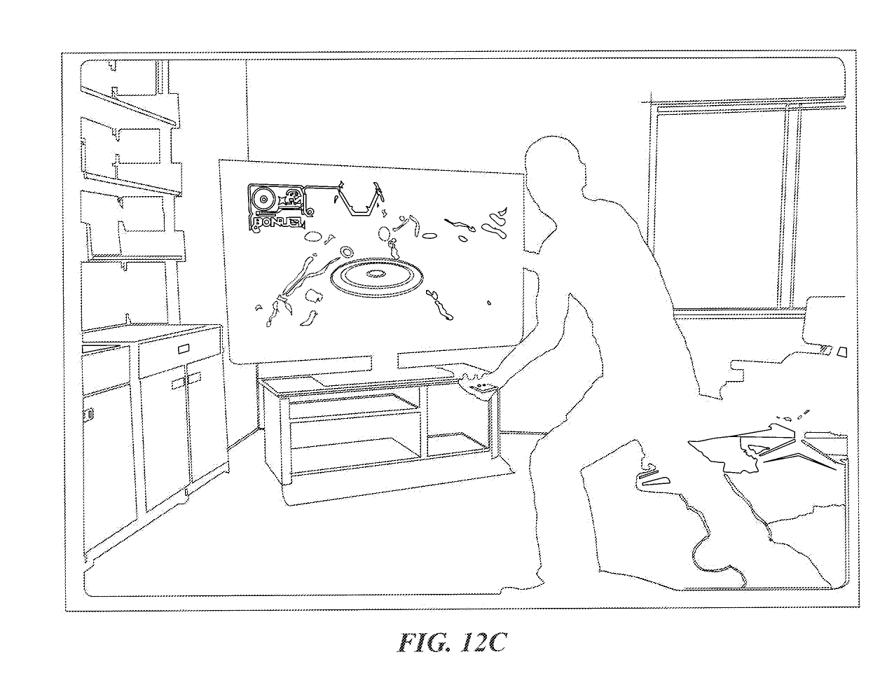

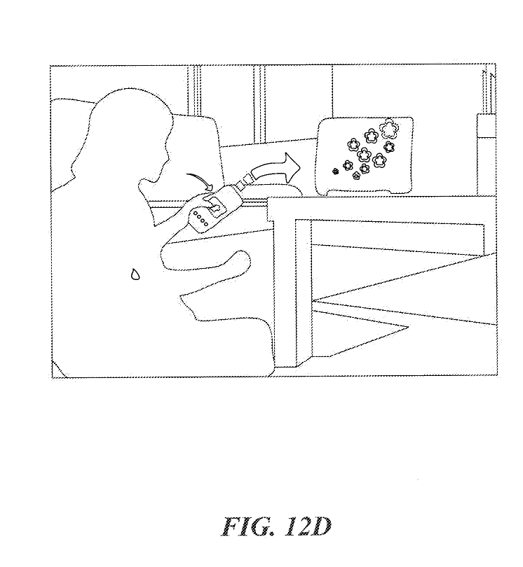

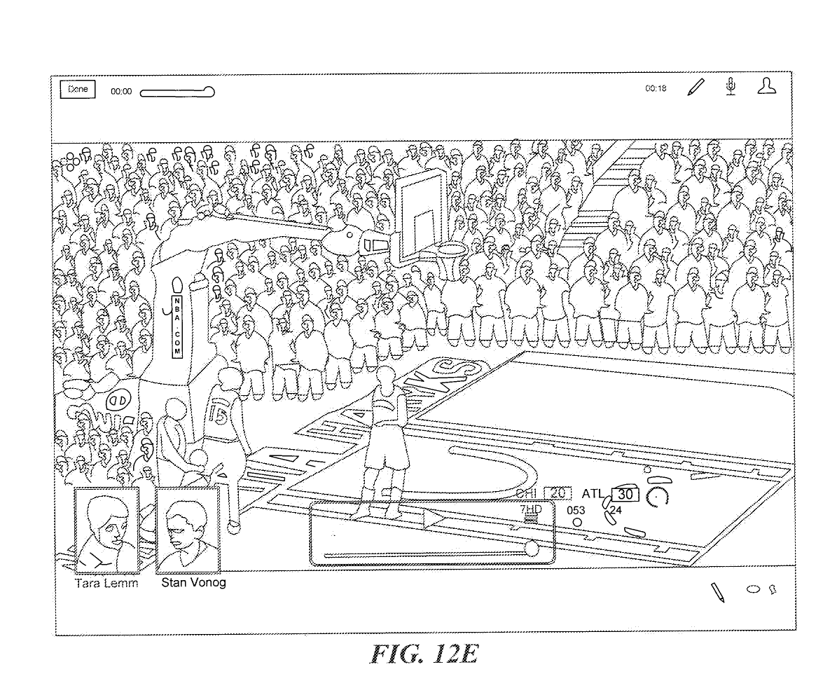

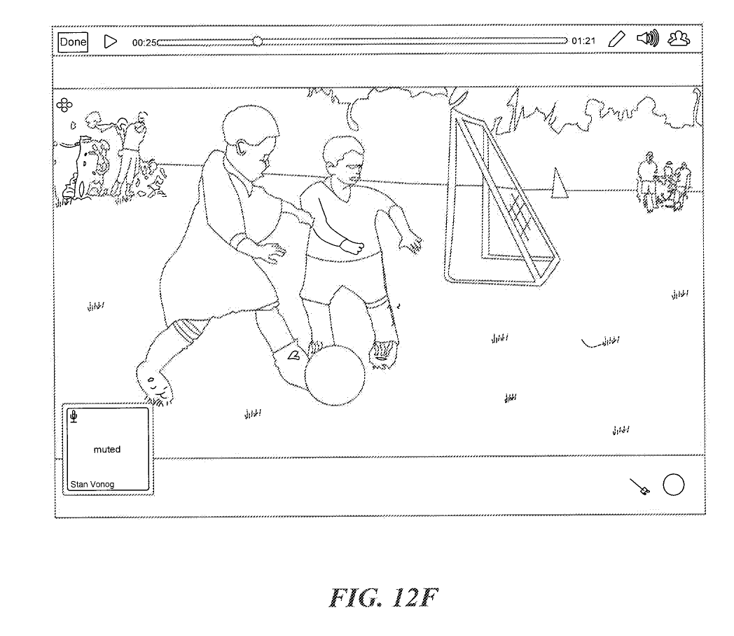

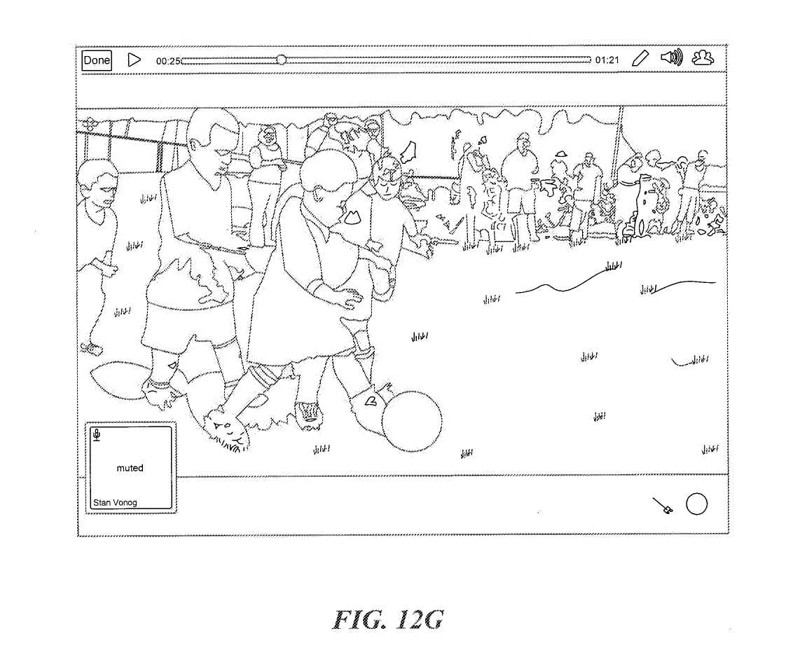

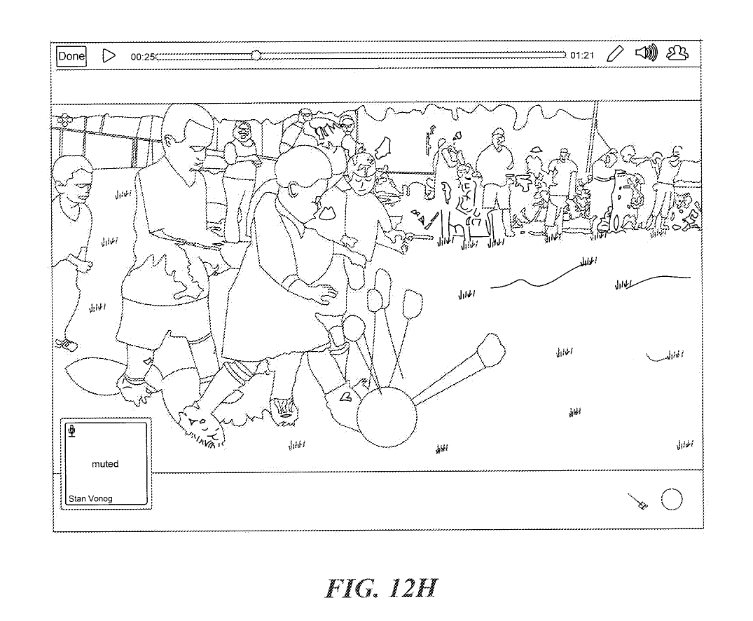

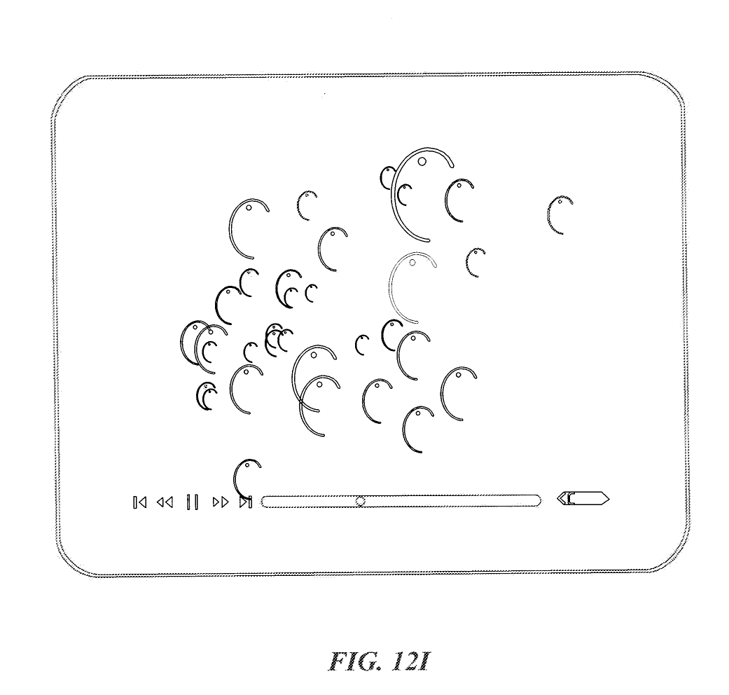

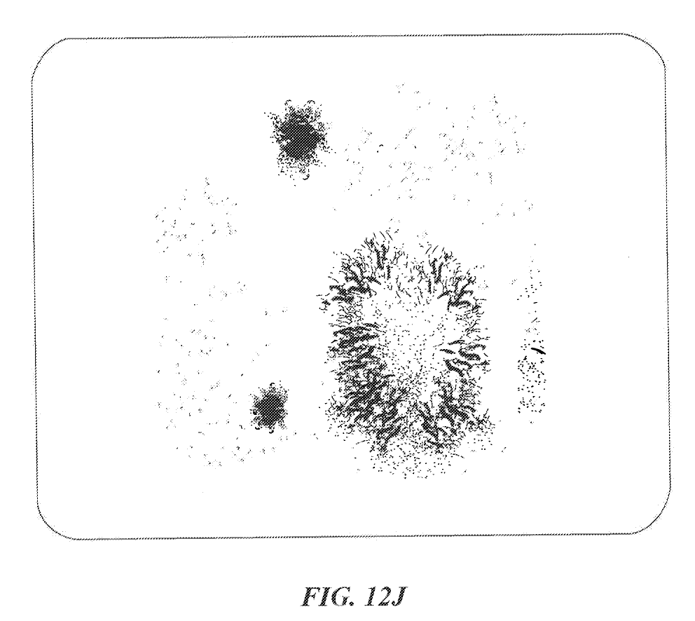

FIGS. 12A-12J now depict various illustrative examples of virtual experiences that may be offered in conjunction with the techniques described herein. FIGS. 12A-12B illustrate an exemplary embodiment of several users connected with respect to an everyday activity, such as watching a football game. In FIG. 12A, users are able to annotate on the video to indicate certain messages, which are also incorporated within virtual experiences initiated by the user. As illustrated in the examples, the virtual experiences pans across multiple devices and device types, including smart phones, entertainment devices, etc.

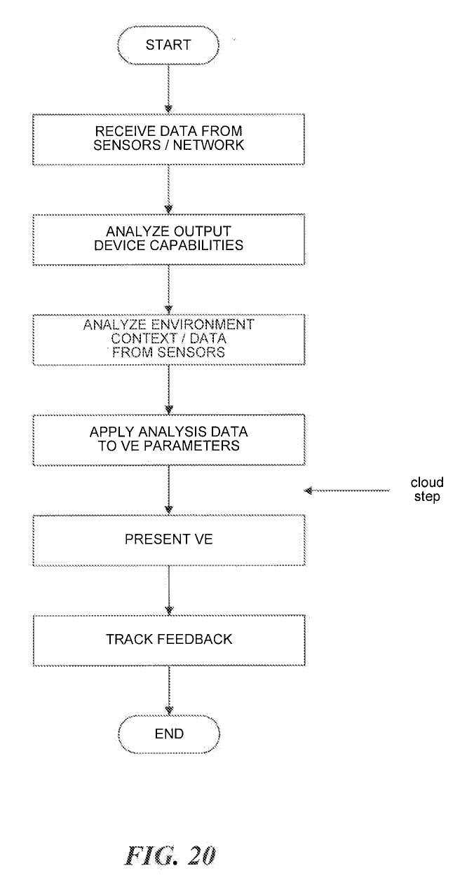

FIGS. 12C-12D depict examples of physical gestures for activation or effectuation of virtual experiences. As illustrated, such experiences can be activated by, for example, a physical motion in conjunction with an iPhone® smart phone device. In some examples, instead of a physical gesture based activation, activation is effected by controlling certain buttons or keys on mobile devices. FIG. 20C illustrates a virtual experience in a gaming application where the user mimics the virtual experience of throwing a disc at an object on the screen by simulating the throwing as a physical gesture using the personal computing device. In return, the asynchronous or synchronous setup proceeds to render the disc and analyze (using, for example, motion sensors inherent to the controller) a direction of throw and a trajectory of throw, and accordingly effectuates the virtual experience. Similar principles are illustrated in FIG. 12D with respect to another virtual experience where a user watching a video with other online users shows her appreciation for a particular scene by throwing flowers on the screen. FIG. 12E is an illustrative example of a “splat” in the tomato throw illustrations discussed above. Similarly, FIGS. 12F-12H illustrate examples where hearts or flowers are thrown or showered as a virtual experience. The reality of the virtual experience is further enhanced by having the flowers hit the desired object at a desired trajectory and further, for example, having the flowers drop off relative to the position at which the flowers are directed toward the screen. FIGS. 12I-12J are additional examples of virtual experiences that may be utilized in conjunction with the techniques discussed herein.

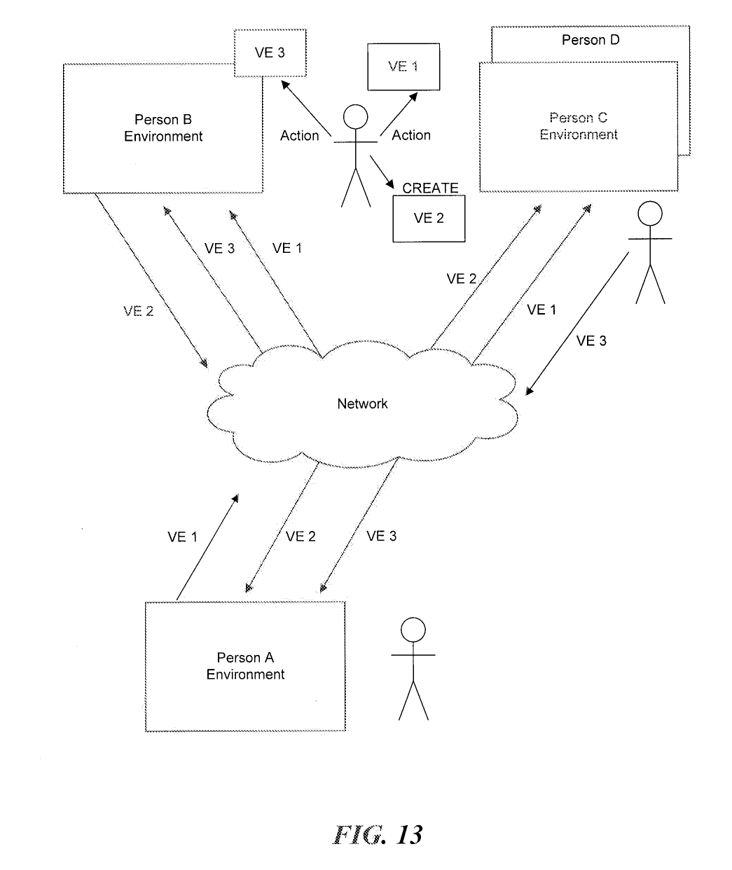

The following sections now describe various general concepts and additional exemplary systems and techniques related to providing virtual experiences. FIG. 13 is a general diagram that describes how virtual experience are created in multi-device social networked environment. Not only can a person create a virtual experience but they can also interact with virtual experiences created by other persons, as illustrated in the figure. In this example, all the interactions are synchronized and presented simultaneously to all the people across the network. FIG. 13 is a general exemplary diagram of a virtual experience direction in a multi-device, multi-sensor, multi-people social environment. This architecture is non-limiting and is intended as a preliminary and basic set up for showing a multi-person multi-device environment. In embodiments, each person can create virtual experiences or interact with a virtual experience created by other people. In illustrations, person A creates VE1 (virtual experience 1) and this virtual experience is sent through the network and broadcast to multiple users (e.g., other participants of the session, person “B” and person “C”). Then, person “B” for example, has a choice—either to interact with an experience created by the person “A,” or he or she can create another experience, which would be presented on top of the experience number one, or may also combine actions done by person B and communicate the experience through the network communicated to each participant of the session and can be presented differently based on the other people, environment, and the context. The key idea here is virtual experience, as compared to prior art, does not involve simple virtual goods sent using a mass message (which is mostly just a picture that is presented to recipients). As introduced herein, the techniques involve virtual stimuli that are in essence different because they are interactive and are broadcasted synchronously. As described herein, synchronous includes broadcasting substantially in real-time, thus providing interaction capabilities.

In one example, two people wearing 3D glasses, powerful computer is powering up to projectors, there are tracking sensors, and people are manipulating through the images and checking sensors to track their hands and arms to create images for them. So these are gestural virtual reality-based human-machine based communication that can be manipulated. Another advantage is multi-touch type gestures, and there are multiple classes of devices in this—multi-touch displays, large and small scale, multi-touch tablets.

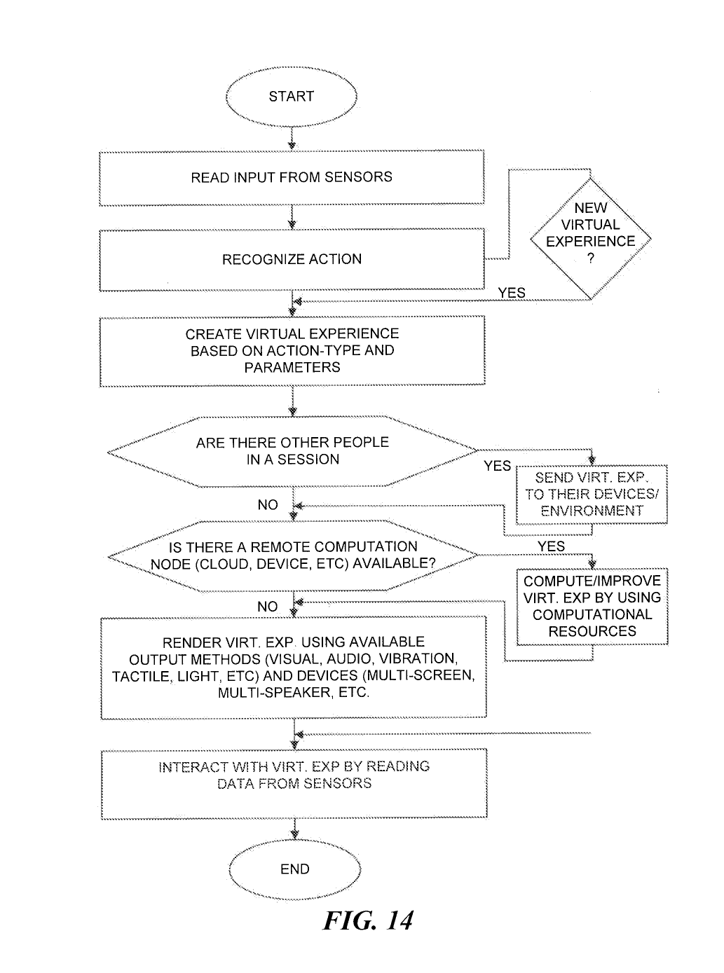

FIG. 14 now presents a basic flow diagram depicting an exemplary process for providing a virtual experience. The process starts with reading input from multiple sensors in the personal environment, and then recognizing the action. The action may be the click of a button, touch to the cell-phone surface or a complex physical gesture. So it doesn't matter for the virtual experience how the action is initiated. The important part here is to recognize an action and then create, based on this action, or classify, whether the action indicates whether the person is creating a new virtual experience or interacting with an existing one. If yes, the process creates a virtual experience based on action time and parameters, and if no, the process proceeds to the next step of interacting with the existing virtual experience.

The next step involves creation of the virtual experience, giving the person immediate feedback with visual, audio and other output capabilities. Subsequently, the process queries whether there are any other people in the session, in a real-time/synchronous or in a asynchronous session. If yes, the process sends information about this virtual experience to a participant or other person's device and environment, and if no, simply proceeds to the next step.

The next step involves the unique idea of using, in at least some embodiments, remote computation. So in the next step, in at least some embodiments, the process determines whether there is a remote computation or cloud device available. If yes, the next step will be to compute and use this computation to either improve the virtual experience or completely do the virtual experience by using this remote computation. It can be just the remote, not accelerating the graphics or helping recognize the complex gesture, or it can be the cloud remote data center, which in a very powerful way can help also display and or present these capabilities to this particular person and other people.

If the process determines a NO here, it simply proceeds to the next step, which is about presenting the rendering of the virtual experience using available output methods. It can be visual, audio, vibrational, tactile, light, or any other capabilities that the person may have in the environment. If the person's device has multiple screens, it can be presented simultaneously, it can be presented in sequence on several screens, or if the person has multiple audio speakers, it can be sequentially or simultaneously, using the positional audio algorithm, or be presented on all of them. In the following step, the process causes interaction with the virtual experience by other participants or the same participants, by reading new data portion from sensors. This entire process then repeats as appropriate.

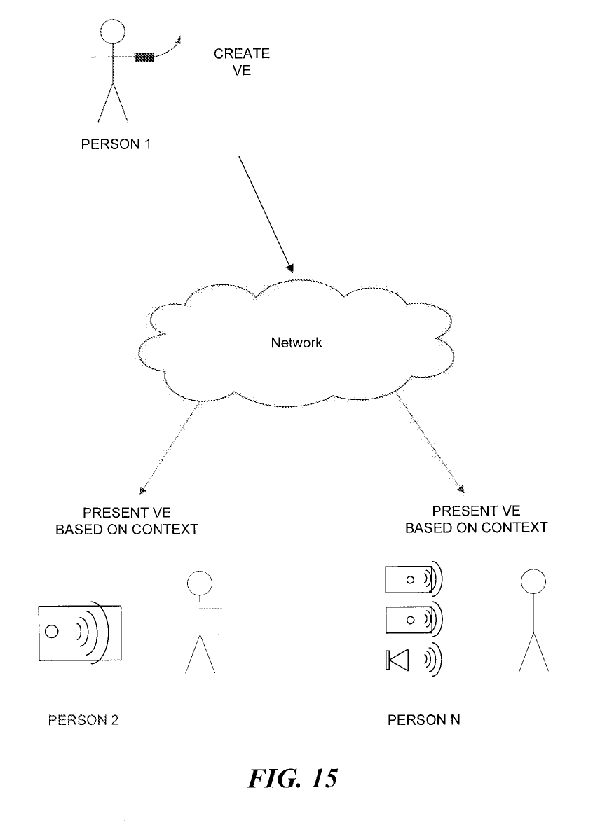

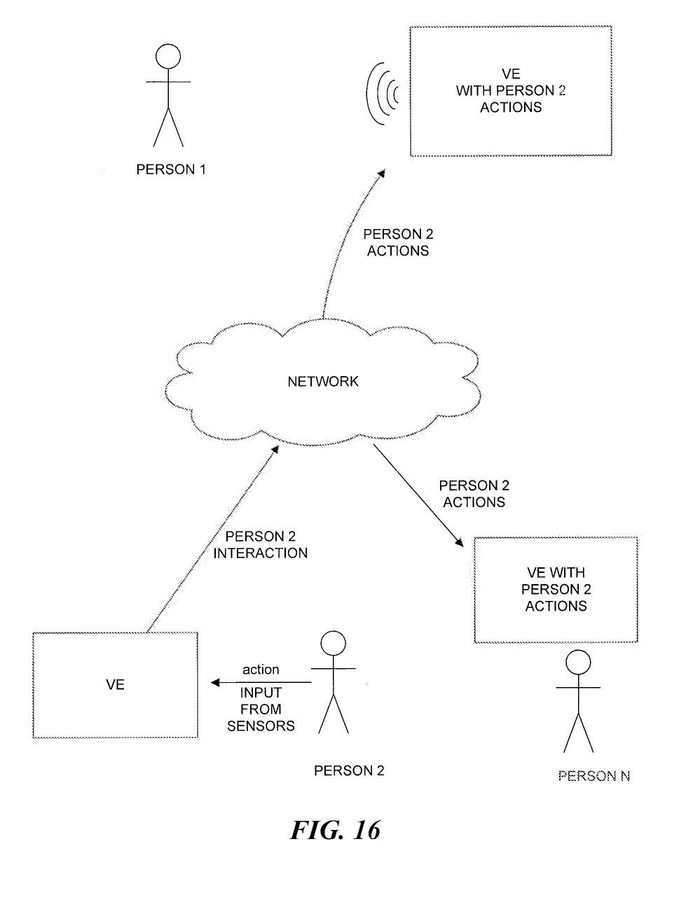

FIGS. 15 and 16 are related and operate, for example, in the architecture described with respect to FIGS. 13 and 14. FIG. 15 illustrates a multi-person environment where the number of persons is unlimited. The first person creates a virtual experience by doing some gesture or action. This is then communicated to other people and presented based on their context. So the context may include the configuration of devices, number of devices, their capabilities, etc. So, in this example, person number two actually has one device, maybe a tablet with audio capabilities so the virtual experience can arrive right on top of this device and can use local computation or cloud computation to accelerate the computation and presentation. For the other person, it can represent multiple devices, multiple speakers, and the central theory is that the presentation of virtual experience significantly depends on the context of the person and the environment.

The next step, as illustrated in FIG. 16, describes the actions from the perspective of person number two. So, person number two gets the virtual experience and provides an action by capturing the input from sensors. The sensors recognize it is a new virtual experience or is an action to an existing virtual experience and sends them info about this interaction and informs all participants of this session. In some embodiments, these actions go back to person in the shape of an experience (person #1 in this case) and provide visual, audio and other types of feedback so that person number one can see the other person interacting with this experience and all the directions come to all other persons. For example, consider the illustrative scenario where presentation of a birthday cake is the virtual experience: person number one can create a birthday cake and send it to everyone else and erson #2 can use the microphone sensors to blow in the microphone and simulate an act of blowing on the candles and these actions can trigger the candles to stop burning. This action may further be sent to person number one and the other persons so they see that not all the candles are burning some of them have actually stopped burning. The other persons may then either create a new virtual experience like maybe throw a knife into this cake to cut it or continue blow to interact with existing virtual experience.

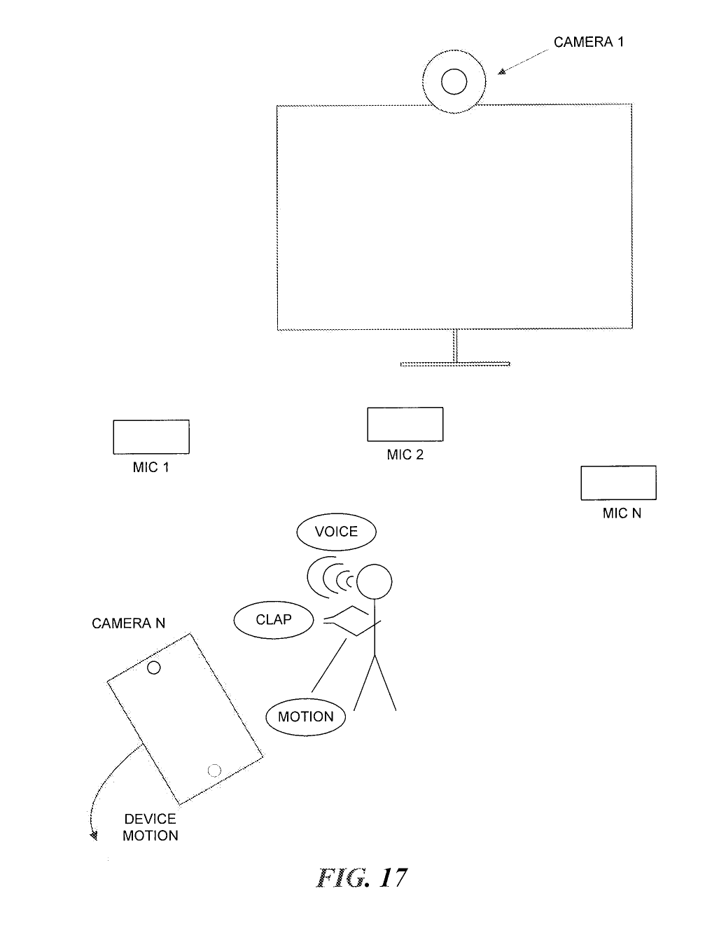

FIG. 17 now illustrates a personal environment where the exemplary environment contains several microphones, several cameras, and several sensors that can track motions. The device sensors or the direct gestural motion for example can be captured through images perceived through the camera to identify a person's motions. In embodiments, the person's motions of applauding, along with voice or other physical gestures may all be incorporated. This presents a scenario where multiple sensors capture multiple actions for the purpose of providing a virtual experience.

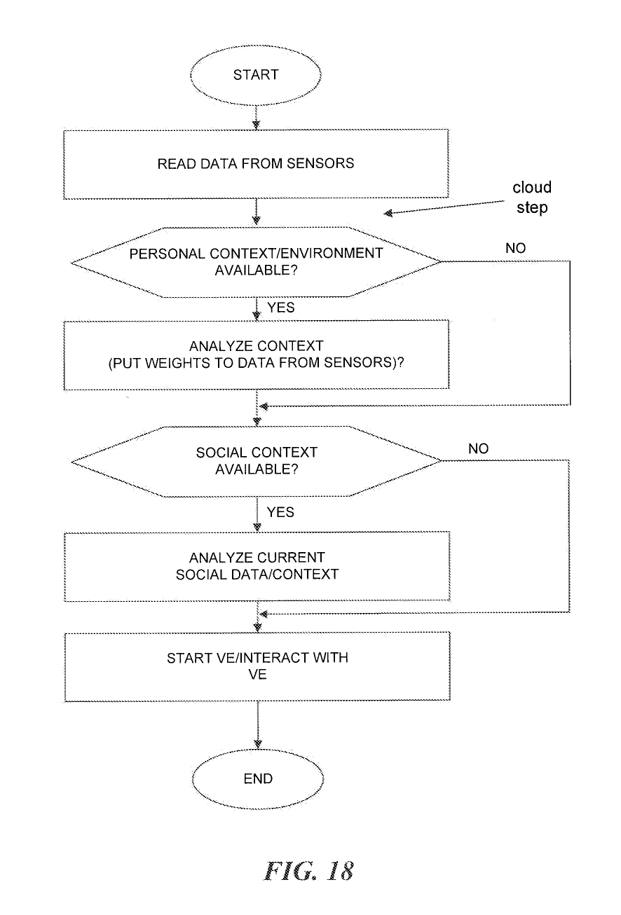

FIG. 18 now illustrates an exemplary process that can be used for the above discussed actions. The process starts by reading data from sensors. The next step may optionally use the cloud for computation to identify recognized personal context or environment data. Is there a personal context environment available? If yes, the process analyzes the context. Analyzing the context involves the following: the person may be in the process of some activity or the person can be with in the movie and the gesture or action may be context specific it is like watching the movie some actions and voice can be completely different from a person watching a football game. So in this case, corresponding actions and commands can be different. For example, if the person gets very excited starts speaking something during the movie the camera recognized that as a highlight in the movie. Another person wishing to supporting them and actually near the person gets excited and starts speaking loud expressing excitement and then can produce some actions (e.g., fan actions like something started to happen on the screen when fireworks started). That is actually very dependable for personal context and the personal environment that basically indicates what kind of device is available and that describes the sensors and the configuration of this particular capturing device. So in the context, depending on the scenario or context, some sensors are given high weightage and some are not. Then the next step will be taking into consideration the social context. The social context: let us say several people working together as a team and some of the people start applauding loudly. So, in this context, if we sensors detect that clap sound this personal environment in this context it is very likely that the person also gets excited and expressed emotional response to this action so it is likely but the person also started applauding. The social context can significantly actually help to increase the accuracy for conditionals of the other person's inputs. So this social context is available to identify the current social data and context to increase the accuracy and information of the received inputs. Accordingly, the virtual experience is started based on the recognition criteria discussed above.

FIG. 19 now illustrates an example input and output environments associated with providing virtual experiences. This may include multiple output devices presented in the personal environment. Some of these devices can be, but not limited to light system, multiple screens, multiple sound speakers, devices that can produce flow of air targeted at the direction of the person, small devices which can provide vibrator effects back to the person, 3-D environment devices using glasses or not using glasses, any other visual or sensory or any other type of input, output that can be perceived by the person and created by the devices, etc.

FIG. 20 is another flow diagram illustrating a method for a virtual experience. The process starts from receiving data from either sensor or from the network, because if the person receive data from the sensors it can create a virtual experience and start rendering them right away or data from the network can be received to create a visual presentation of new virtual experience created by other people. Device capabilities are analyzed in the next step, creating in the environment, a virtual map of the virtual physical space that exists in the environment for providing the virtual experience. Similar to the description presented above, the data from the sensors is used to analyze environment context or data. The important idea here is the analyzing of data from sensors and context from the environment, and presenting a virtual experience that is tailored by the rules defined by the experience by itself. Consequently, the next step in the algorithm is applying all this analysis data virtual experiences parameters, which can be different, how it's presented, how the sound moves, how the lighting moves, et cetera. Subsequently, the virtual experience is provided. In some instances, the process tracks the feedback from the person, how the person reacts to this, and then starts over based on particular situations.

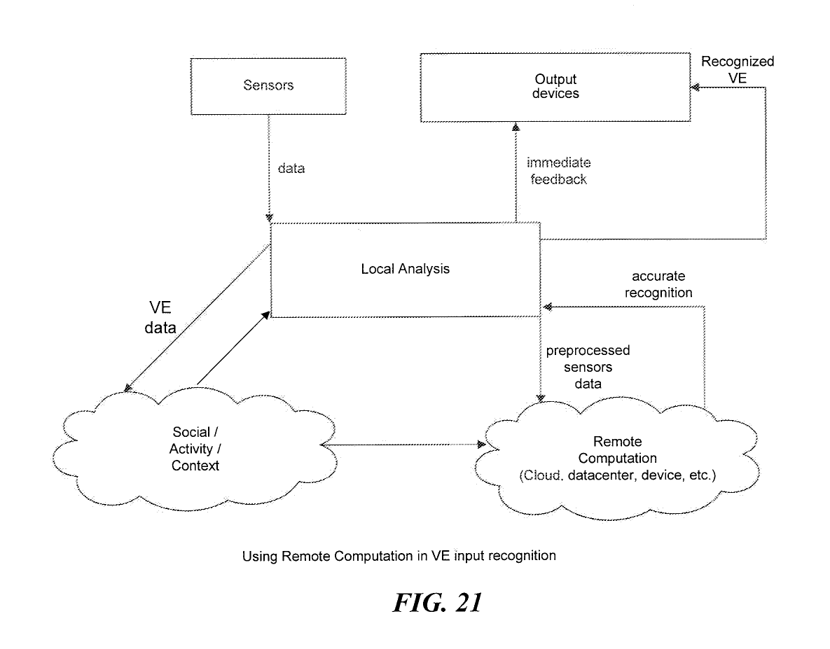

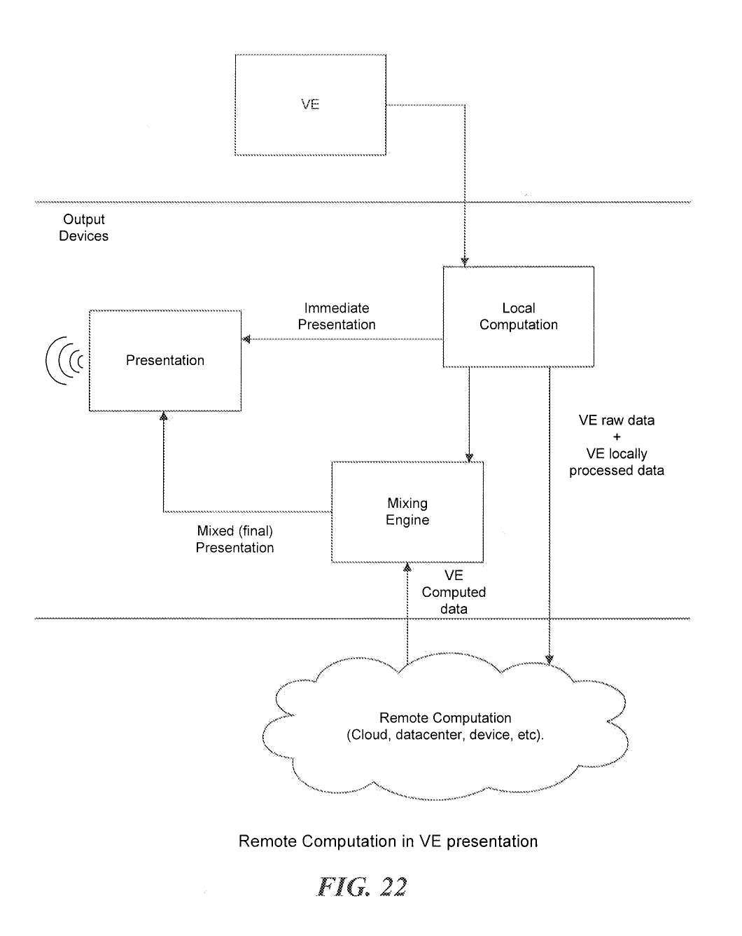

FIGS. 21 and 22 illustrate examples of using remote computation in virtual experience input recognition. FIG. 21 illustrates immediate feedback from simple local analysis and starting remote cloud effect to increase efficiency of computation (example: clapping-->simple claps at shaking phone—then recognized by the server turns into beautiful applause rendered as virtual experience). FIG. 22 illustrates rendering a simple effect at the start that is eventually blended into a great cloud-assisted effect. FIG. 22 illustrates scenarios of an intelligent mixing engine synchronized with basic effects. (e.g., firework rendering starts with rendering 4 sparks locally and then merges into a full force firework).

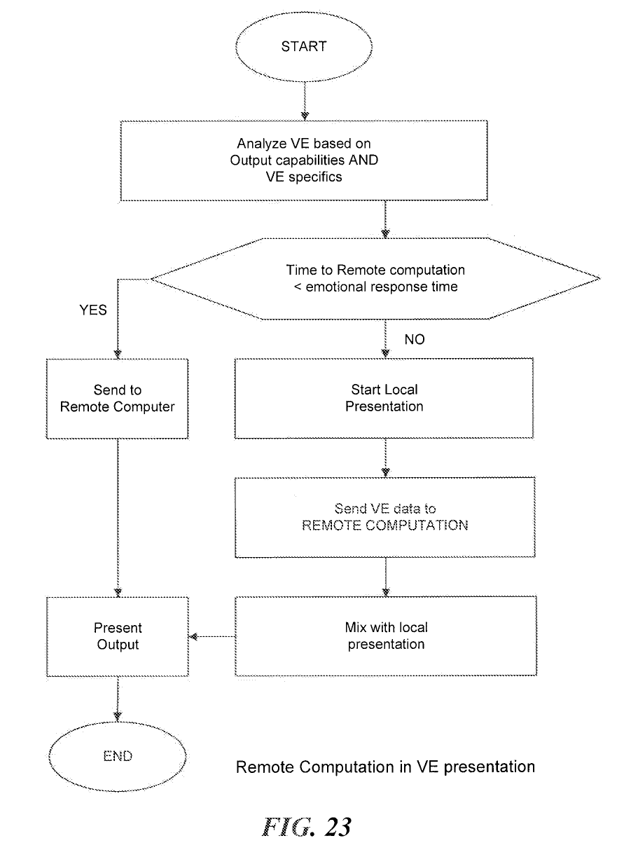

FIG. 23 is a flow diagram illustrating how remote computation is used during presentation of a virtual experience. The process starts with analyzing virtual experiences based on output devices' capabilities and virtual experience parameters: type of virtual experience and its origination (from local person or other people in the session). The next step is to compare the time it takes to present the virtual experience using remote computation and emotional response time requirement for this particular virtual experience. The system calculates this time based on the current information about network, time required to do a remote presentation. If the remote computational time is less than the emotional response time required, the virtual experience can be fully processed and presented by using computation resources of the remote node. If the remote computation takes a long time (>emotion response time required for the virtual experience), the system starts local presentation immediately based on available resources. In parallel the system sends data to the remote computation node and the remote computation node computes and processes this data and sends it back to the mixing engine. The mixing engine can mix the local results produced on the screen with the remote computation results. The engine mixes the final presentation and sends the presentation back to output devices. In this case, remote computation node can significantly enhance the realistic effect of presentation. Let's consider an example of a “Fireworks” virtual experience: a person activates fireworks by a certain action or gesture. Once “Fireworks” are activated the images and sounds of exploding fireworks appear on the person's screens and devices. Let's assume the person has a device with limited computational capabilities that can not render the fireworks in full beauty. However the device is capable of decoding and render the video stream that represents the animation which is rendered on a remote server. In order to generate immediate feedback, the system starts rendering the animation locally using a particle animation engine on the device. Due to computational resource constraints the engine can only render a limited number of fireworks. When the local particle engine starts rendering the fireworks the cloud rendering is activated. While the local animation proceeds the cloud-rendered stream arrives and is smoothly merged with the locally-rendered animation making the beautiful fireworks happen on the device with limited computing capabilities providing a richer visual and audio experience.

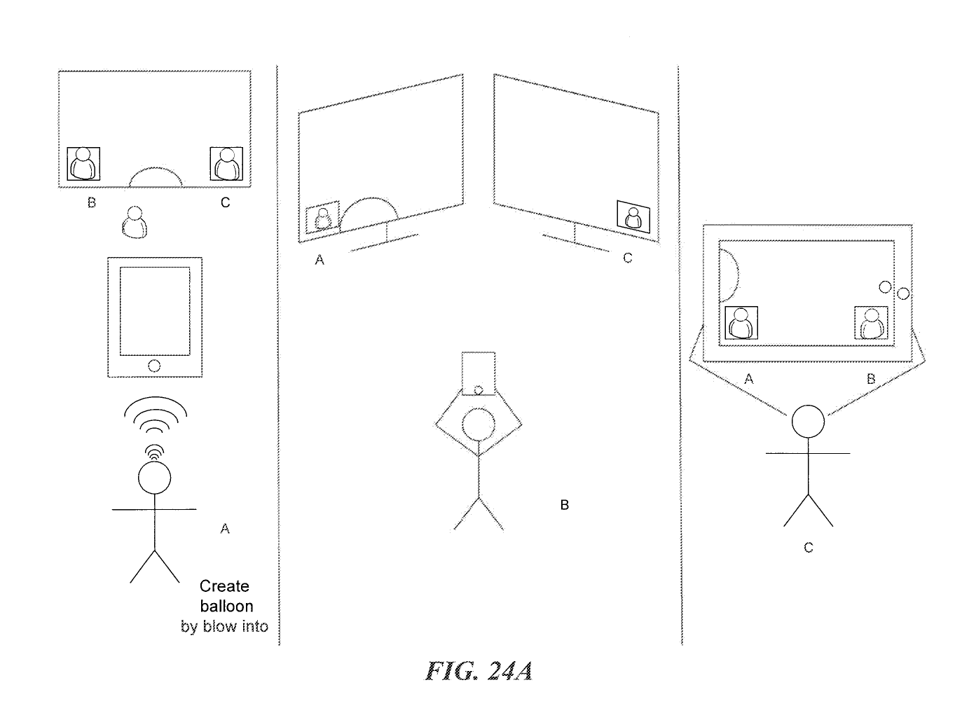

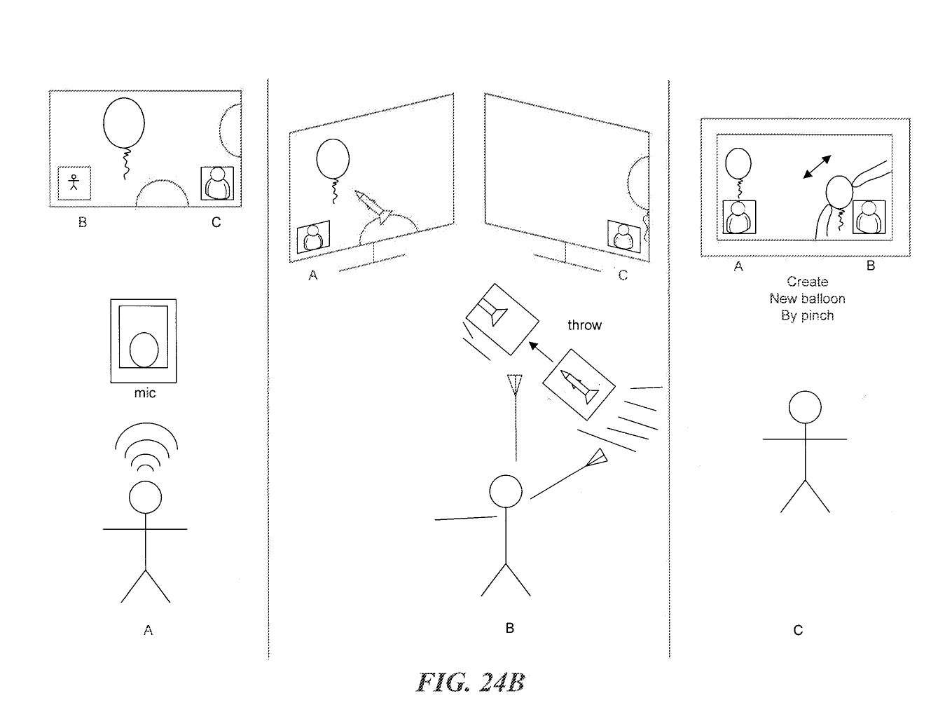

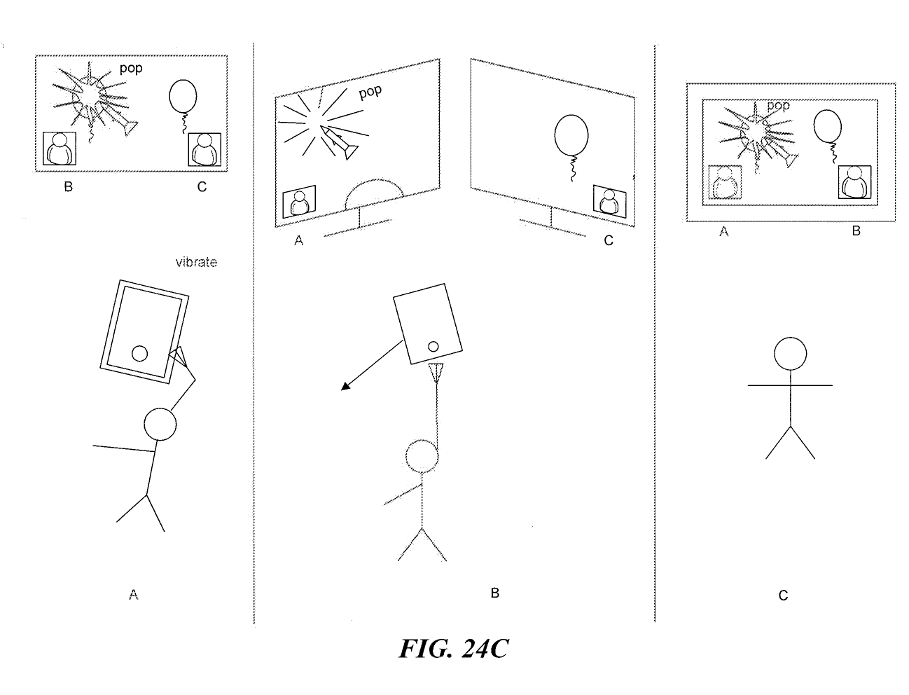

FIGS. 24A-C depict illustrative examples of virtual experiences. In FIG. 24. A, Person A blows in the microphone of a mobile device to create virtual balloons. First, the balloon appears on the Person's A mobile device, as a real-life object starts appearing on the screen and goes up. Person B sees this balloon that appears on the screen to the left of where person A is located. Person B identifies the appearance of the balloon as a result of the action of person A. Person C also sees the balloon appearing on the screen of his tablet device. People A, B, C can be in the same location or separated by thousands miles connected by the Internet. In FIG. 24B, Person B selects a “dart” virtual experience and aims to the left screen. The devices space orientation, velocity—all impact the “Dart” virtual experience and how it interacts with the balloon virtual experience. Person B performs a throw gesture. The dart starts leaving the iPhone screen and starts showing up on the left TV screen. At the same time Person C is creating a new balloon by pinching on the surface of their multi-touch screen. Since C's device has relatively low limited capability the remote processing in the cloud started the process of rendering the balloon animation remotely and when the pinching is done the high quality virtual experience is transmitted from the cloud. In FIG. 24C, the dart can interact with the balloon. This action is synchronized and displayed simultaneously across the whole ensemble.

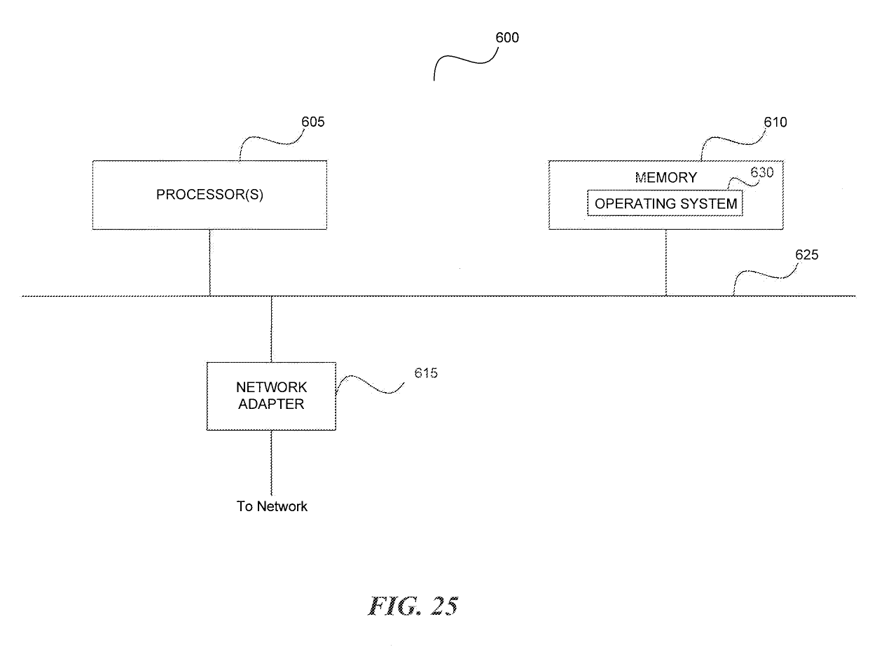

FIG. 25 is a high-level block diagram showing an example of the architecture for a computer system 600 that can be utilized to implement a data center, a content server, etc. In FIG. 25, the computer system 600 includes one or more processors 605 and memory 610 connected via an interconnect 625. The interconnect 625 is an abstraction that represents any one or more separate physical buses, point to point connections, or both connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 605 may include central processing units (CPUs) to control the overall operation of, for example, the host computer. In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 610 is or includes the main memory of the computer system 1100. The memory 610 represents any form of random access memory (RAM), read-only memory (ROM), flash memory (as discussed above), or the like, or a combination of such devices. In use, the memory 610 may contain, among other things, a set of machine instructions which, when executed by processor 605, causes the processor 605 to perform operations to implement embodiments of the present invention.

Also connected to the processor(s) 605 through the interconnect 625 is a network adapter 615. The network adapter 615 provides the computer system 600 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed. Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A computer implemented method of providing an interactive virtual experience, the method comprising:
receiving, by an experience server, a request from a first client device of a plurality of client devices to initiate a virtual experience, the plurality of client devices connected over a communication network with the experience server, wherein the plurality of client devices are interconnected in an interactive communication platform over the communication network; and
communicating, by the experience server, with the first client device and a second client device of the plurality of client devices to generate and convey the virtual experience, wherein:
the virtual experience includes a virtual good component and an animation component, the animation component involving a graphical animation of the virtual good component across displays associated with the first and second client devices;
the animation component of the generated virtual experience spans across displays of the first and second client devices, the animation component having a starting animation sequence displayed on the first client device, a trailing animation sequence that virtually creates a visual interconnection between the first client device and the second client device, and an ending animation sequence displayed on the second client device.

2. The method of claim 1, wherein said receiving a request from a first client device includes receiving a gesture from a user of the first client device, the gesture indicative of the request to initiate the virtual experience.

3. The method of claim 2, wherein the gesture includes a physical gesture by the user, indications of the physical gesture transmitted to the experience server by sensors associated with the first client device.

4. The method of claim 2, wherein the gesture is indicative of one or more parameters associated with the animation component, each parameter being on of: a velocity indicator, a directional indicator, or a trajectory indicator.

5. The method of claim 5, wherein the experience server incorporates the one or more parameters indicated by the user's gesture, the incorporated parameters influencing production of the animation sequence across the first and second client devices.

6. The method of claim 1, wherein the displays or the first client device and the second client device are virtually stitched in association with at least one edge of the displays, further wherein the animation component spans across the first client device and the second client device such that the display of the second client device virtually operates as an extension of the display of the first client device.

7. The method of claim 1, further comprising:
generating and conveying the virtual experience from the first client to a sub-plurality of client devices of the plurality of client devices, the sub-plurality including the second client device and one or more other client devices from the plurality of client devices, further wherein the animation component of the generated virtual experience spans across displays of the first client device and each of the sub-plurality of client devices.

8. The method of claim 7, wherein the virtual experience is conveyed from the first client device to the sub-plurality of client devices in a synchronous mode, wherein in the synchronous mode:
the animation component of the generated virtual experience spans across displays of the first and each of the sub-plurality of client devices, the animation component having a starting animation sequence displayed on the first client device, a trailing animation sequence that virtually creates a visual interconnection between the first client device and each of the sub-plurality of client devices, and a substantially similar ending animation sequence displayed on each of the sub-plurality of client devices.

9. The method of claim 8, wherein the virtual experience is conveyed from the first client device to the sub-plurality of client devices in an asynchronous mode, wherein in the asynchronous mode:
the animation component of the generated virtual experience spans across displays of the first and each of the sub-plurality of client devices, the animation component having a starting animation sequence displayed on the first client device, a distinct trailing animation sequence that virtually creates a visual interconnection between each of the plurality of client devices, and an ending animation sequence displayed on a last one of the sub-plurality of client devices.

10. The method of claim 8, wherein the virtual experience is conveyed from the first client device to the sub-plurality of client devices using a combination of synchronous and asynchronous modes.

11. The method of claim 1, further comprising:
providing a virtual experience store in association with the experience server, the virtual experience store including one or more of: a plurality of virtual goods; or a plurality of animation sequences associated with virtual experiences.

12. The method of claim 11, further comprising:
provisioning to the first client device a virtual good and/or an animation sequence upon receiving a request from a user associated with the first client device to purchase said virtual good and/or animation sequence;
enabling the user to initiate the virtual experience utilizing the virtual good and/or animation sequence purchased from the virtual experience store;
generating the virtual experience with features commensurate to the purchased virtual good and/or animation sequence.

13. The method of claim 12, further comprising:
subsequent to the virtual experience being conveyed to the second client device, enabling a second user associated with the second client device to purchase the virtual good and/or animation sequences associated with the received virtual experience from the virtual experience store.

14. An experience server comprising:
a network adapter through which to communicate with a plurality of client devices via a communication network;
a memory device coupled to the network adapter and configured to store code corresponding to a series of operations for delivering media content to a client device from the plurality of client devices, the series of operations including:
receiving a request from a first client device of a plurality of client devices to initiate a virtual experience, the plurality of client devices connected over a communication network with the experience server, wherein the plurality of client devices are interconnected in an interactive communication platform over the communication network; and
communicating with the first client device and a second client device of the plurality of client devices to generate and convey the virtual experience, wherein:
the virtual experience includes a virtual good component and an animation component, the animation component involving a graphical animation of the virtual good component across displays associated with the first and second client devices;
the animation component of the generated virtual experience spans across displays of the first and second client devices, the animation component having a starting animation sequence displayed on the first client device, a trailing animation sequence that virtually creates a visual interconnection between the first client device and the second client device, and an ending animation sequence displayed on the second client device.

15. The experience server of claim 14, wherein said receiving a request from a first client device includes receiving a gesture from a user of the first client device, the gesture indicative of the request to initiate the virtual experience.

16. The experience server of claim 15, wherein the gesture includes a physical gesture by the user, indications of the physical gesture transmitted to the experience server by sensors associated with the first client device.

17. The experience server of claim 15, wherein the gesture is indicative of one or more parameters associated with the animation component, each parameter being on of: a velocity indicator, a directional indicator, or a trajectory indicator.

18. The experience server of claim 17, wherein the experience server incorporates the one or more parameters indicated by the user's gesture, the incorporated parameters influencing production of the animation sequence across the first and second client devices.

19. The experience server of claim 14, wherein the displays or the first client device and the second client device are virtually stitched in association with at least one edge of the displays, further wherein the animation component spans across the first client device and the second client device such that the display of the second client device virtually operates as an extension of the display of the first client device.

20. The experience server of claim 14, further comprising:
generating and conveying the virtual experience from the first client to a sub-plurality of client devices of the plurality of client devices, the sub-plurality including the second client device and one or more other client devices from the plurality of client devices, further wherein the animation component of the generated virtual experience spans across displays of the first client device and each of the sub-plurality of client devices.

21. The experience server of claim 20, wherein the virtual experience is conveyed from the first client device to the sub-plurality of client devices in a synchronous mode, wherein in the synchronous mode:
the animation component of the generated virtual experience spans across displays of the first and each of the sub-plurality of client devices, the animation component having a starting animation sequence displayed on the first client device, a trailing animation sequence that virtually creates a visual interconnection between the first client device and each of the sub-plurality of client devices, and a substantially similar ending animation sequence displayed on each of the sub-plurality of client devices.

22. The experience server of claim 21, wherein the virtual experience is conveyed from the first client device to the sub-plurality of client devices in an asynchronous mode, wherein in the asynchronous mode:
the animation component of the generated virtual experience spans across displays of the first and each of the sub-plurality of client devices, the animation component having a starting animation sequence displayed on the first client device, a distinct trailing animation sequence that virtually creates a visual interconnection between each of the plurality of client devices, and an ending animation sequence displayed on a last one of the sub-plurality of client devices.

23. The experience server of claim 22, wherein the virtual experience is conveyed from the first client device to the sub-plurality of client devices using a combination of synchronous and asynchronous modes.

24. The experience server of claim 14, wherein the set of operations further includes:
providing a virtual experience store in association with the experience server, the virtual experience store including one or more of: a plurality of virtual goods; or a plurality of animation sequences associated with virtual experiences.

25. The experience server of claim 24, wherein the set of operations further comprises:
provisioning to the first client device a virtual good and/or an animation sequence upon receiving a request from a user associated with the first client device to purchase said virtual good and/or animation sequence;
enabling the user to initiate the virtual experience utilizing the virtual good and/or animation sequence purchased from the virtual experience store;
generating the virtual experience with features commensurate to the purchased virtual good and/or animation sequence.

26. A system comprising:
an experience server coupled to a plurality of client devices over a communications network;
a first client device of the plurality of client devices configured to initiate a request for a virtual experience;
a second client device of the plurality of clients configured to be an intended target of the virtual experience;
wherein, the experience server is further configured to:
receive the request from the first client device to initiate the virtual experience, wherein the plurality of client devices are interconnected in an interactive communication platform over the communication network; and
communicate with the first client device and the second client device to generate and convey the virtual experience, wherein:
the virtual experience includes a virtual good component and an animation component, the animation component involving a graphical animation of the virtual good component across displays associated with the first and second client devices;
the animation component of the generated virtual experience spans across displays of the first and second client devices, the animation component having a starting animation sequence displayed on the first client device, a trailing animation sequence that virtually creates a visual interconnection between the first client device and the second client device, and an ending animation sequence displayed on the second client device.
